(19) United States
(12) Patent Application Publication
(10) Pub. No.: US 2011/0072085 A1
(43) Pub. Date: Mar. 24, 2011

(54) EVENT RECONCILIATION SYSTEM AND METHOD

(76) Inventor: StJohn Standley, Surrey (GB)

(21) Appl. No.: 12/886,325

(22) Filed: Sep. 20, 2010

Related U.S. Application Data
(60) Provisional application No. 61/243,618, filed on Sep. 18, 2009.

(51) Int. Cl. G06F 15/16; G06F 3/048; G06F 17/30

(52) U.S. Cl. 709/204; 707/748; 715/835; 707/755

(57) ABSTRACT

A computer-implemented method of and system for matching a first and a second different independently-created descriptions of a shared event involving at least two persons is described. The method comprises: receiving each of the first and second descriptions of the shared event respectively from each of a first and a second user's communications device; generating a first set of descriptive variables from the first received description and a second set of descriptive variables from the second received description, the first and second set of variables including the location of the event, the time/date of the event and at least one variable describing the appearance of at least one of the at least two persons; determining a matching value for each variable common to both the first and second sets; using the matching values of the first and second sets to establish the likelihood of whether the first and second descriptions describe the same event; and sending the results of the using step to each of the first user's communication device and the second user's communications device.

### TECHNICAL FIELD

The present invention relates to an event reconciliation system and method. More particularly, though not exclusively, the present invention relates to the field of social networking, and providing technological support for assisting in the automated reconciliation of two or more independently created data descriptions of a past shared event.

### BACKGROUND

There has been a significant increase in the number of social networking applications, accessible via the Internet, in recent times. As people have begun to recognise the vast opportunities for networking, presented by the Internet, traditional forms of networking have been replaced, as people become more receptive to the alternative networking opportunities presented by the Internet. This is confirmed by the growing use of social networking websites such as facebook™, myspace™, and twitter™. The growing influence the Internet exerts on the modern world is multifaceted and has had a significant impact on the way people communicate and interact, even affecting the way individuals search for and find partners. The growth of the online dating market evidences this, and has become a multi-million dollar industry with millions of users.

Dating websites are a specific type of social networking application, and traditionally used to be stigmatised as suitable for only social introverts lacking the required skills to interact directly with people. Increasingly hectic modern lifestyles, where working long hours are the norm, and free time is limited, has gradually contributed to the success of dating websites, to the point where dating websites are now a respected means of networking and meeting potential partners. The success of dating websites is demonstrable by the fact that they represent the third highest grossing type of online paid content sites, preceded only by gaming sites, and digital music sites!

The majority of dating websites function by storing a user profile, comprising a picture and often other personal information about the user. Users of the dating website browse through the plurality of user profiles and contact any user whose profile has caught their interest. Such websites often attempt to match the interests and desired requirements of each registered user by matching profiles to form a shortlist of potential end dates. There are many pitfalls to such a model. First, and as many users of dating websites may have discovered by first-hand experience, user profiles are not necessarily accurate and factual. Often fake photographs or other non-factual data is posted, and such “inaccuracies” are only verifiable once physical contact with the person has been established, often resulting in embarrassment for both parties. Another pitfall of traditional dating websites is that they often attract sexual predators and other undesirables, and hence there is always an element of risk and underlying uncertainty when meeting people through dating websites for the first time. Finally, the matching process is initially carried out in a virtual environment, namely the initial decision to select a potential candidate is not carried out by the individual.

A general need exists to remove such inherent risks from the online dating market.

In everyday life, people make eye contact with hundreds of individuals but on certain occasions, two people may experience a brief encounter and make a connection, through extended eye contact, or maybe a smile, yet through fear of rejection it is rare that a person will approach a stranger and act upon their initial instinctive feelings, even if both people may have experienced the same feeling. Both individuals are then left with a sense of regret for not having acted in accordance with their feelings, when the opportunity presented itself. There is currently no means for two such individuals to retrospectively meet or contact each other. No currently available dating website can provide a solution to this problem, and yet such missed opportunities occur on a daily basis throughout the world. In addition there is no technical solution at present available which addresses the problem of enabling two participants in an encounter event to be able to be reconciled. Most single people, have experienced this sense of missed opportunity on more than one occasion. Furthermore, people tend to be more comfortable meeting with a person with whom they have shared such an experience, than with a complete stranger that contacts them over the internet on the basis of a dating website profile.

A genuine need exists for a means to allow people who have experienced a mutual feeling, but for fear of rejection did not take advantage of the opportunity, to establish contact. Further, in a technical sense, there is a need to provide a technological mechanism to support such event reconciliation.

### SUMMARY OF THE INVENTION

The present invention presents a system and method for the reconciliation of two different data descriptions and/or views of a shared time-location event, as provided by two different independent sources, such as from communications devices of two different people. The present invention also provides a system and method for identifying the sources of a shared time-location event, on the basis of descriptions of the shared event, as provided by the sources. On the basis of a mutually confirmed identification of the two independent sources of the shared time-location event, the system and method of the present invention provides means for the sources to establish contact.

More specifically, according to one non-limiting aspect of the present invention there is provided a computer-implemented method of matching a first and a second different independently-created descriptions of a shared event involving at least two persons, the method comprising: receiving each of the first and second descriptions of the shared event respectively from each of a first and a second user's communications device; generating a first set of descriptive variables from the first received description and a second set of descriptive variables from the second received description, the first and second set of variables including the location of the event, the time/date of the event and at least one variable describing the appearance of at least one of the at least two persons; determining a matching value for each variable common to both the first and second sets; using the matching values of the first and second sets to establish the likelihood of whether the first and second descriptions describe the same event; and sending the results of the using step to each of the first user's communication device and the second user's communications device.

Additionally, the present invention addresses the technical problem of how to reconcile two different data descriptions, provided by two different independent sources, without disclosing the identity of the sources, until a positive reconciliation of the different descriptions has been effected. Once the independently provided descriptions have been reconciled and confirmed as relating to a shared time-location event, the identities and/or means of contacting the two independent sources are disclosed.

Furthermore, the present invention provides solutions to the above identified problems, whilst simultaneously minimising the amount of information about the shared time-location event required from the sources. The amount of information, which must be elicited from the sources, to reconcile the independently provided descriptions of the shared time-location event is kept to a minimum.

To increase the efficiency of the system and method, the present invention attributes pre-stored weighting factors to the plurality of common variables used to describe an event to create a net of weighted matching values which can then be used for establishing the likelihood of the descriptions relating to the some event. This enables the method and system to account for the potentially inaccurate descriptions of the shared time-location event provided by the independent sources. Reconciliation is performed on the basis of a probabilistic analysis and comparison of the independently provided descriptions.

### BRIEF DESCRIPTION OF THE DRAWINGS

FIGS. 1a, 1b and 1c are a series of sequential scenes showing the occurrence of a shared time-location event;

FIG. 2 is a schematic diagram showing a system embodying the present invention in which different communications channels are available for sending a query message relating to the shared time-location event for example shown in FIG. 1, and for seeking further information relating to the event;

FIG. 3 is a process flow chart showing how two different query messages relating to the same shared time-location event are reconciled by the system of FIG. 2;

FIG. 4 is a block diagram which provides a functional overview of a server shown in FIG. 2;

FIG. 5a is a detailed process flow chart showing how the validation system of FIG. 4 works;

FIG. 5b is a detailed process flow chart showing how the message handling system and match generation system of FIG. 4 process and generate matches between user queries as outlined in steps 136 and 138 of FIG. 3;

FIG. 5c is a detailed process flow chart showing how the match generation system of FIG. 4 ensures that a match between two messages provided by different users is mutual, as outlined in steps 146 and 148 of FIG. 3;

FIG. 6 is a block diagram showing a functional overview of a message handling system of FIG. 4;

FIG. 7 is a process flow chart showing how the appropriate query template is issued by the message handling system of FIG. 6;

FIG. 8 is a process flow chart showing how the message handling system of FIG. 6 generates a formalised query from a received user provided message;

FIG. 9 is a block diagram showing a functional overview of the match generation system of FIG. 6;

FIG. 10 is a process flow chart showing how the match generation system of FIG. 9 reconciles two different descriptions of a shared time-location event;

FIG. 11a illustrates the general structure of a user query in accordance with an embodiment of the present invention, which is handled by the system of FIG. 2;

FIG. 11b illustrates the general structure of a formalised user query as formalised by the message handling system of FIG. 6, and processed by the match generation system of FIG. 9;

FIG. 12 illustrates a graphical user interface used on a communications device of FIG. 2 such as a mobile telephone;

FIG. 13 is a process flow chart showing how the validation system of FIG. 4 ensures a received user request has been issued by a registered user;

FIG. 14 is a process flow chart showing how the registration system of FIG. 4 works, in accordance with an embodiment of the present invention; and

FIG. 15 illustrates how the present system and method may be used to map the movements of a subject in accordance with an alternative embodiment.

### DETAILED DESCRIPTION OF PRESENTLY PREFERRED EMBODIMENTS

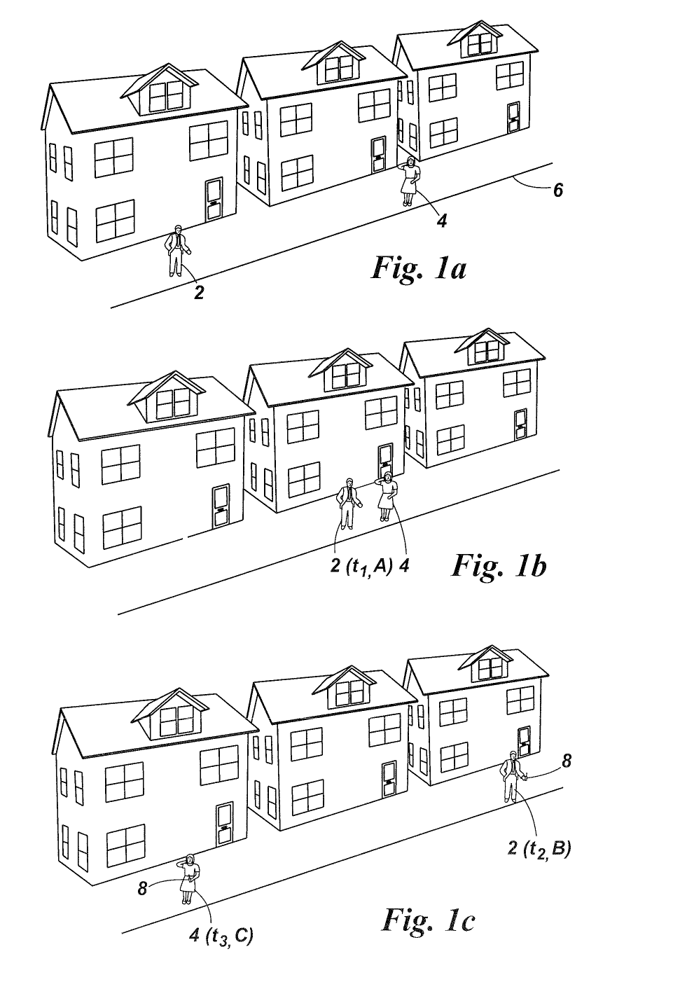

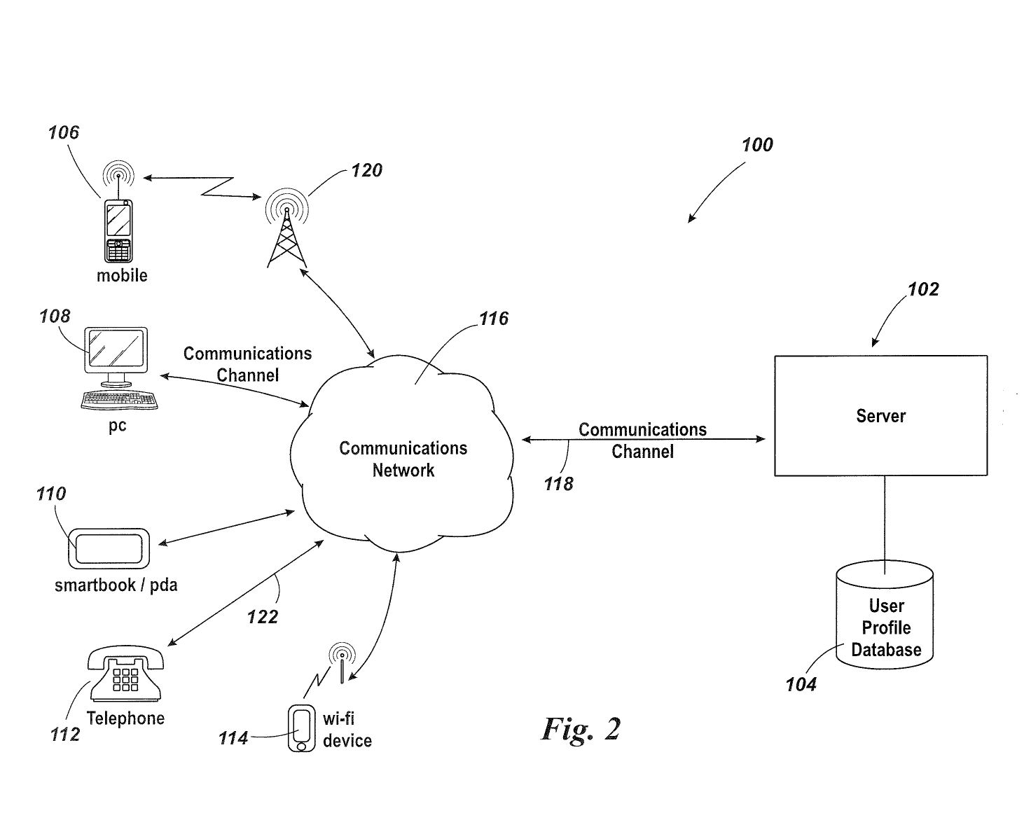

An embodiment of the present invention is described hereinafter with reference to FIGS. 2 to 14. However, in order to better understand the present embodiment, one of the many possible contexts in which the present embodiment is used is now described with reference to FIGS. 1a, 1b and 1c. This important context is to match different user-provided descriptions of a shared time-location event, namely an event which occurs at a particular location at a particular point in time. In this context, the shared-time-location event relates to a brief encounter between two individuals at a specific location and point in time. Hereinafter the terms ‘match’ and ‘reconcile’ will be used interchangeably to refer to the matching of different user-provided descriptions of a shared time-location event, as relating to the same time-location event.

Referring to FIGS. 1a, 1b, and 1c, a sequence of events in time is shown which illustrate a scenario in which a shared time-location event is generated and which an embodiment of the present invention may be used to obtain further information about. Present FIGS. 1a to 1c are included herein to aid the reader in developing an appreciation of the practical context in which the present invention may be used, but is not intended to be limiting in any way. Various other shared time-location events may occur for example, which give rise to a need for use of the present invention.

Referring to the figures in greater detail, FIG. 1a depicts two users 2 and 4, who are strangers, approaching each other along a street 6, before a shared time-location event occurs. The two users 2 and 4 share a time-location event at a particular time t₁ and location A, as illustrated in FIG. 1b. For example, the shared time-location event may involve the exchange of a smile between users 2 and 4. However, this is not strictly necessary and the shared time-location event could relate to any type of shared event (see below for a more comprehensive discussion). After the shared time-location event, users 2 and 4 continue along their respective paths, as illustrated in FIG. 1c.

In accordance with the present embodiment, using their respective mobile telephones 8, users 2 and 4 may each record the details of the shared time-location event, and generate respective descriptions of the shared time-location event, with the objective of locating the other user party to the shared time-location event. The descriptions are transmitted to a central system which analyses the different descriptions and identifies correlations between the descriptions. The correlations are used to identify different descriptions provided by different users, which relate to the same shared time-location event. Once the different descriptions have been identified that relate to the same time-location event, the respective users that generated the descriptions, are provided with their opposite parties contact details. Users 2 and 4 are thus provided with a method and system for establishing contact at a time after the shared time-location event has occurred. In this way, a user 2 that has been party to a shared time-location event is provided with a method for identifying and contacting his/her opposite member—user 4—on the basis of an analysis of the different descriptions of the shared time-location event, as provided by the two users party to the event.

It is to be appreciated that the description of the shared time-location event data is described retrospectively, after the shared time-location event has occurred, by users 2 and 4. Accordingly, the provided descriptions relate to subjective user-generated recollections of an event. The subjective and potentially inaccurate nature of such descriptions resulting from the imperfect recollection by users, mean that very different facts may be relayed in the descriptions of the same event. For example, user 2 may record event data (t₂, B) (occurring at time t₂, and a location B) whilst user 4 may record (t₃, C). This presents a non-trivial technical problem, in that it is not a simple task for the system to resolve automatically these different descriptions, which in many cases may present different and sometimes contradictory information, to identify the unique actual shared time-location event. Despite the differences which may be inherent in the provided descriptions, a match between the two descriptions can still be established by the system. Once a match has been established, this is an indication of both users' wish to be informed about how to contact the other user. Accordingly, the system can provide the contact address details (such as mobile phone number) of each unknown user to the other user, once the two provided descriptions have been reconciled as relating to the same shared time-location event. The present system and method is flexible enough to take into account the nature of human memory such as imperfect recollection and the subjective nature of human descriptions of the same event but nonetheless is able to generate matches between recorded event data.

The system used to carry out the reconciling of different shared event descriptions is the subject of the following description of an embodiment of the present invention. The skilled reader will appreciate that whilst the below described embodiment illustrates how two subjective independently created descriptions of a shared time-location event are reconciled, there is no limit to the number of descriptions which may be reconciled. For example, the system may equally be used to match three independently created descriptions of a shared time-location event between three different users.

FIG. 2 is an overview of a system 100 in accordance with an embodiment of the present invention. The system comprises a central server 102 which carries out the core functionality of performing the description matching and communicating with a communications device of the user 2,4. The server 102 is provided with access to a user profile database 104, which is either located locally or remotely to the server 102. User terminals provide the user with communication means for interacting with the server 102, and may comprise one or more of a mobile device 106, personal computer/laptop 108, smartbook/PDA (personal data assistant) 110, telephone 112, or portable wireless enabled device 114, that communicate with server 102 via a shared communications network 116, which in turn is connected with server 102 via a shared communications channel 118. The communications network 116 may relate to the internet, or any other type of communications network accessible by both the user terminals and the server 102. Each of the user terminals 106, 108, 110, 112, and 114 is provided with a specific type of communications channel for connecting to communications network 116. For example, the mobile device 106 connects to the communications network 116 via a mobile telephone network 120, such as a GSM or 3G network. It is to be understood that for a mobile device 106 and/or a telephone 112 to connect to the server 102, intermediary stages are required which are not shown. This may include routing the signal through a telephone exchange, and then onto a gateway which converts the telecommunications signal into a different communications format, such as internet protocol (IP), which is communicable with server 102. This also enables the server 102 to handle SMS/MMS messages from the mobile device 106, via a Short Message Service Centre (SMSC) and an appropriate communications gateway. Use of a telephone 112 requires in addition to an intermediary telephone exchange, an audio syntactic analysis system capable of recognising and interpreting an oral description of an event, and generating a data message therefrom for forwarding to the server 102. The wireless device 114 connects to the communications network 116 via a wireless network using a wireless communications standard, such as provided by the IEEE 802.11 standard. The wireless device 114 may relate to any wireless enabled device, such as Apple's iPod touch®, Apple's iPad®, a wireless network enabled portable computer, or any other wireless enabled device. Similarly, the system 100 is adapted to allow remote connections from smartbooks and/or PDA's 110, as well as personal computers 108 via fixed or mobile telecoms channels.

The system of the present embodiment is adapted to allow a plurality of different types of electronic communication devices, having differing processing capabilities, to connect to the server 102 and benefit from the services provided by the system and methods of the present embodiment. The server 102 identifies the type of user terminal device seeking to communicate with the server 102, and adapts the provisioning of information content according to the processing capabilities of the user's device. For illustrative purposes, only five different types of remote user terminal have been illustrated connecting to the server 102. However, it should be noted that the present system is adapted to handle a plurality of connections from a plurality of different user devices, and in use at any one time there may be a plurality of different users, using different devices connected to the server 102. There is no definite quantifiable limit to the number of different users that can connect to the server 102 of the system 100. The only limiting factors to the number of connections the server 102 can accommodate, are the processing capabilities of the server 102, and the available bandwidth provided by communication channel 118.

As has been mentioned above, within the context of the present embodiment, a time-location event or shared time-location event refers to any event which occurs at a particular time and at a particular location in the presence of at least two people. A time-location event may be expressed as a function of the variables characterising the event, such as geographical location, the time the event occurred, the appearance of the people who were party to the event, to list but a few examples. The event may relate to a chance encounter between two people in a street, or on a train, or at a music festival who may have shared a brief smile and/or a brief glance. It is irrelevant for the purposes of the present embodiment if the encounter comprised an active interaction or a passive interaction (a passive interaction may be considered to be an interaction wherein no dialogue or physical interaction is occurs) between the two parties. For example, two people crossing paths on a particular street at a specific time, who's eyes meet and they smile at each other, have shared a passive time-location event. An example of an active interaction may be a physical interaction between strangers such as a lively verbal encounter. The system and method of the present embodiment, provides users, who have shared a time-location event, with the ability to establish contact with one another, on the basis of their retrospectively provided descriptions of the shared event.

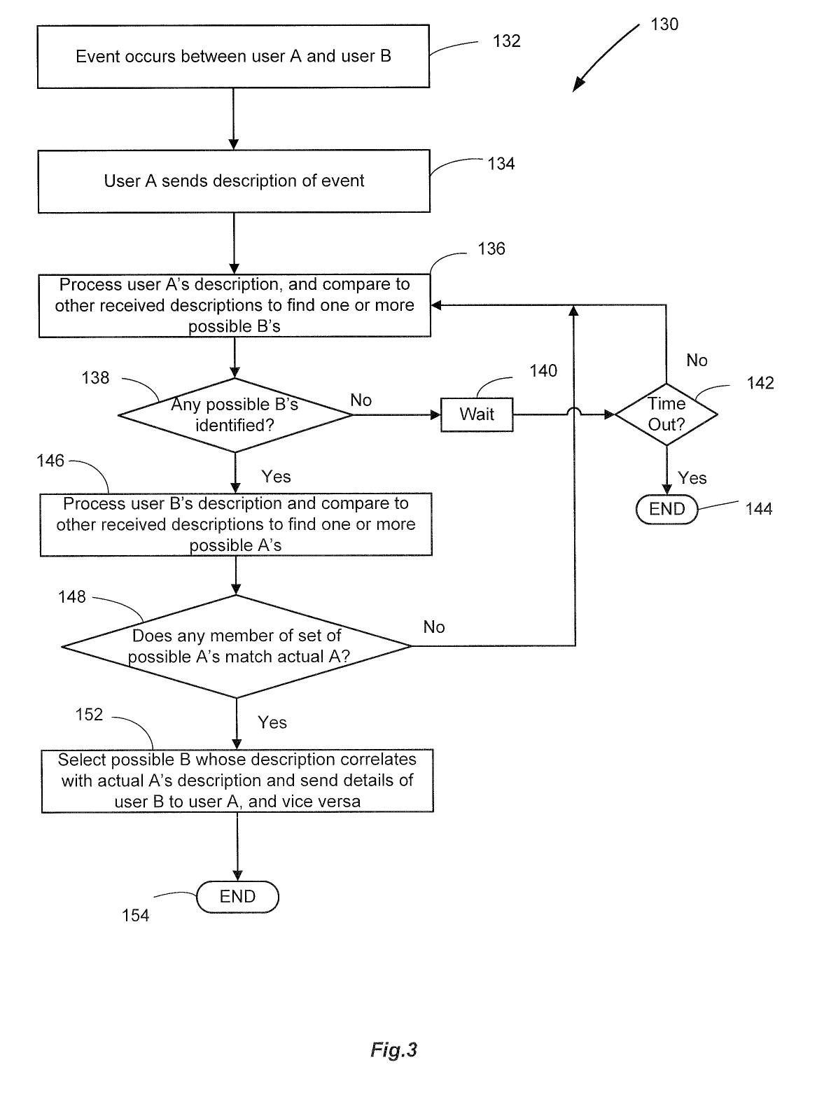

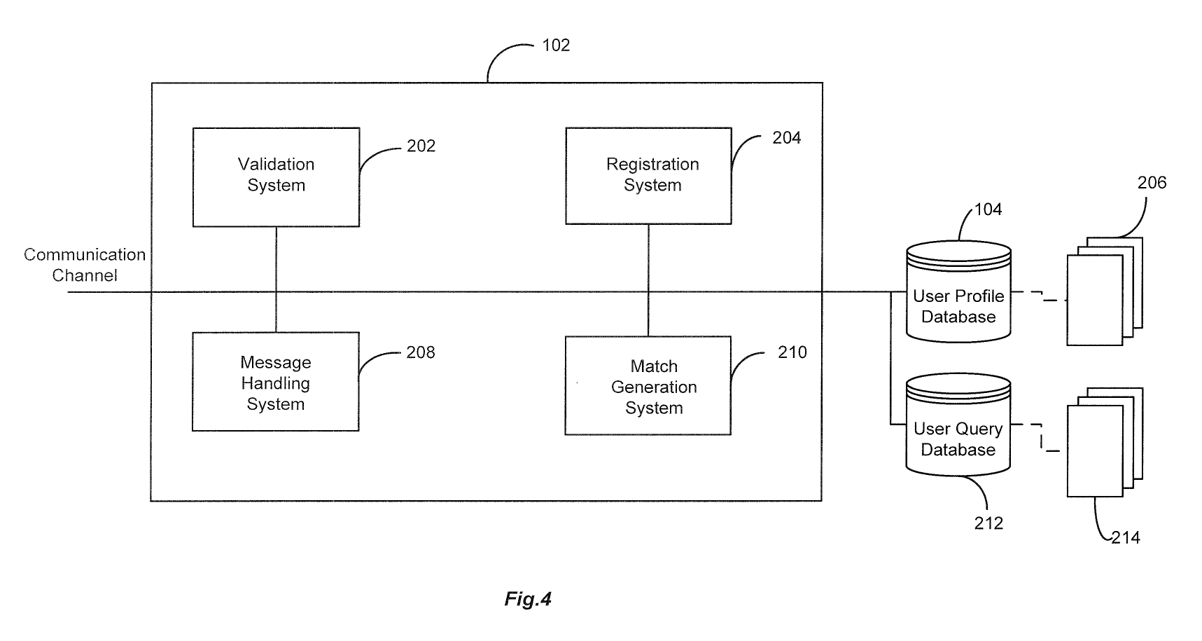

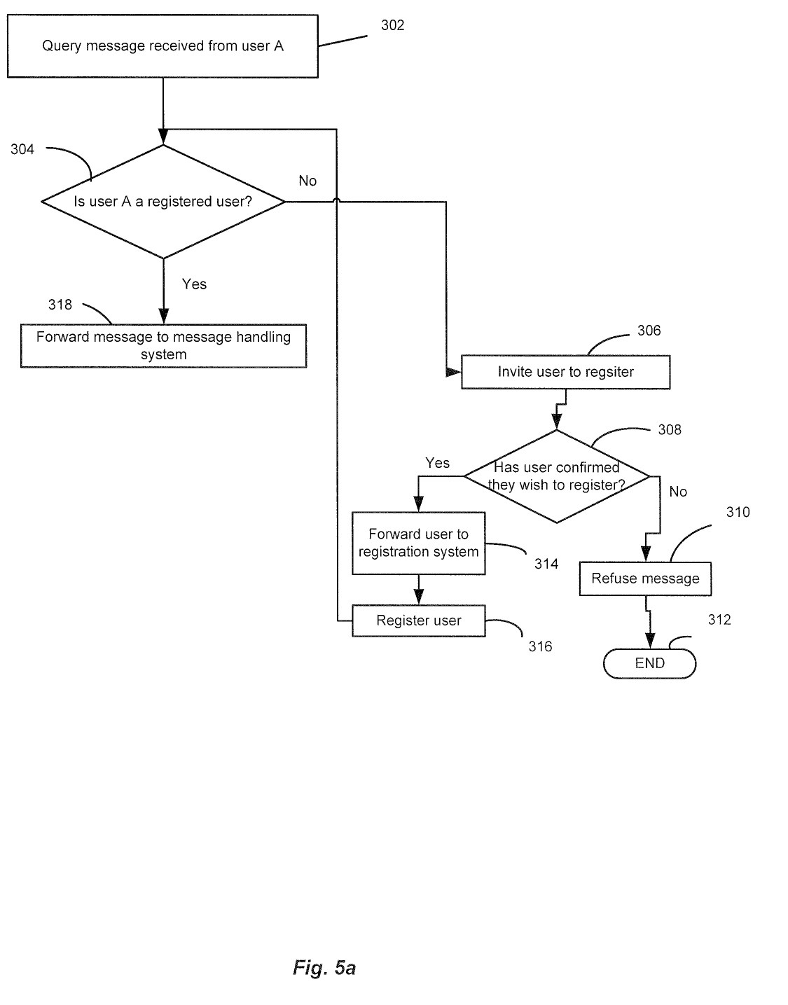

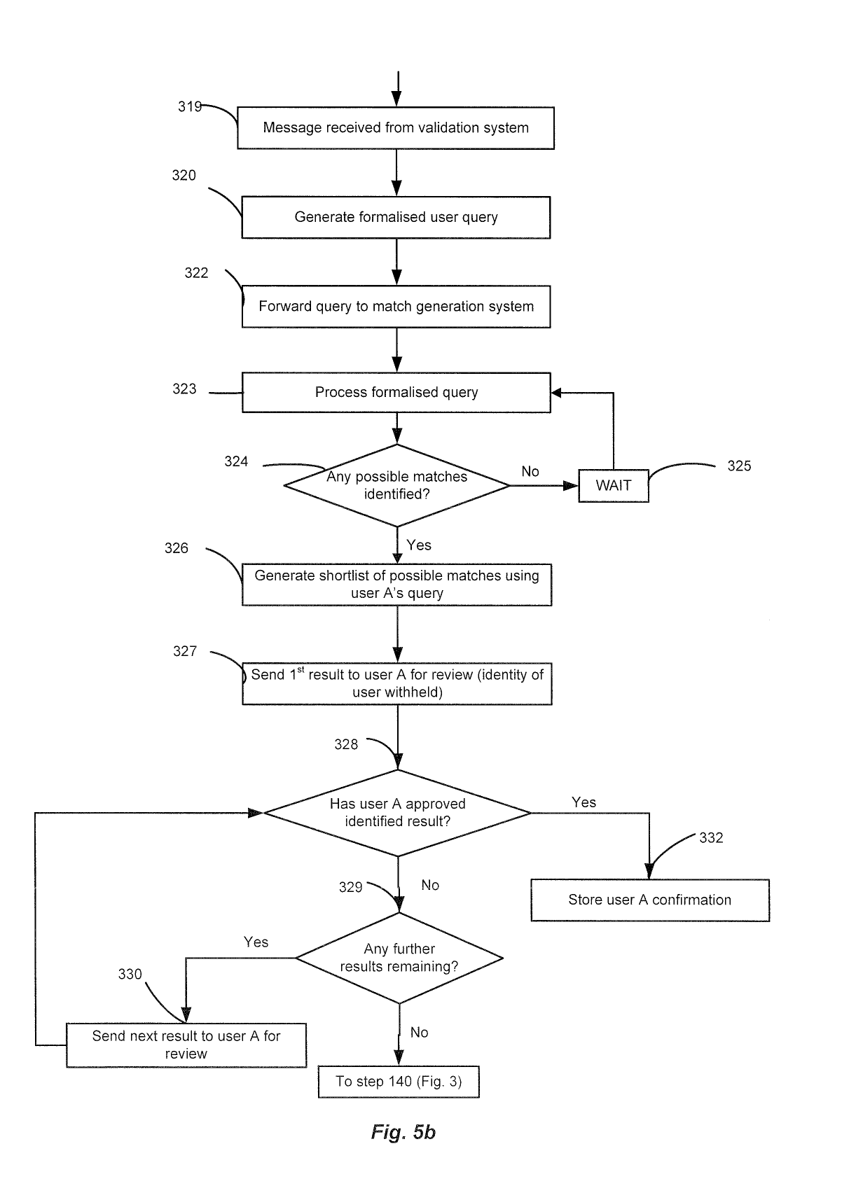

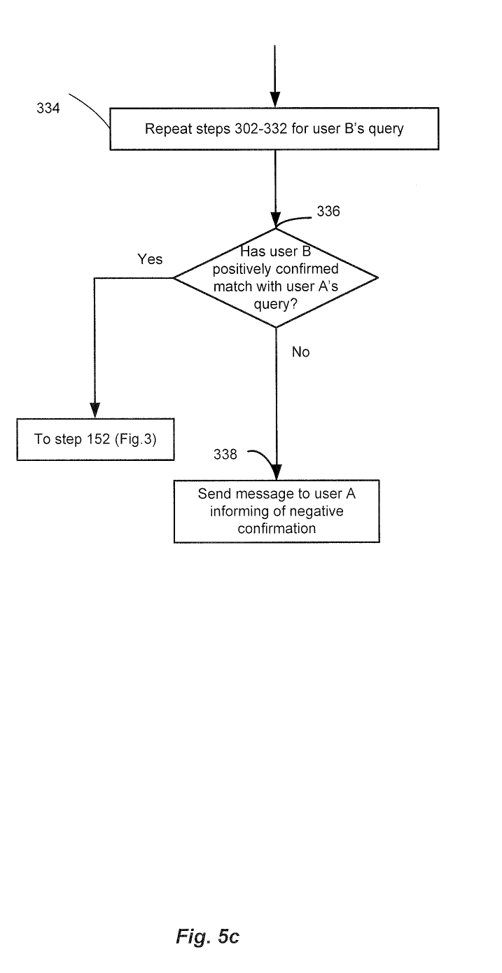

FIG. 3 is a generalised overview 130 of a method used by the server 102 to reconcile two different descriptions of an event, provided by two different users—user A and user B respectively. For illustrative purposes, consider that both users A and B were party to a shared time-location event. FIG. 3 is described from the perspective of user A, who is using the present system with the objective of establishing contact with user B, with whom the time-location event was shared. It should be noted that the system and method of the present embodiment only provide a way for establishing contact between the subjects party to a shared time-location event, provided that both parties have expressed an interest in contacting the opposite party, by issuing a description of the shared time-location event to the server 102. It is an applied constraint of the current application of this embodiment that the desire to establish contact must be mutual between the requesting parties.

Users A and B share at step 132 a time-location event. Following the shared event, user A sends at step 134 a description of the shared time-location event, to the server 102, using an available user terminal 106, 108, 110, 112, or 114. The description of the shared time-location event is user A's recollection of the event, and will include information relating to at least partly the physical appearance of user B with whom the event was shared. The server 102 processes at step 136 user A's description and compares the description with other received descriptions of shared time-location events to identify correlations between the descriptions. In other words, the server 102 identifies a list of potential user-provided descriptions, each of the descriptions having been authored by a different user, which have been identified as potentially associated with user A's provided description. On this basis the server 102 is able to generate a shortlist of possible users, who may have shared the time-location event with user A.

The server 102 determines at step 138 whether any possible user B's have been identified. If no possible user B's have been identified, than the server 102 will wait at step 140 for a predetermined amount of time before repeating the reconciliation process of step 136. The objective of repeating the reconciliation process after a predetermined amount of time is to compensate for scenarios whereby user A's description and user B's description are received by the server 102 at different times. For example, the descriptions may be received on alternate days, in which case the server 102 is not likely to identify any potential B's until user B's description has been received and processed. Repeating the reconciliation process of step 136 at different time intervals minimises the likelihood of the server 102 erroneously returning a negative result, which may occur if the two descriptions are received at different times. The server will continue to periodically perform the reconciliation process of step 136 until either a positive match with user B's description is made, or a predetermined amount of time has lapsed—referred to as a “time out” period in step 142. The “time out” period of step 142 may relate to several days, months, or years, and is at the service providers discretion. The process 130 is effectively terminated at step 144 once the time out period has lapsed.

The server 102 may be configured to either batch process received user descriptions at pre-defined times, defined by the service provider, or may continuously process received user descriptions in steps 136 and 138.

Once the server 102 has identified one or more possible user B's and the result of step 138 is positive, then the descriptions associated with the possible B's are processed and a shortlist of possible A's is generated at step 146. The shortlist of possible A's relates to the possible user descriptions which correlate to the possible B's descriptions. In effect the descriptions associated with the possible B's are now processed at step 146 to identify possible users who may be user A. At step 148 the server determines if any of the possible A's relate to the actual A. If none of the possible user A's match the actual user A, then subsequent cycles of the process steps 136-148 are repeated. To minimise the processing requirements placed on the server 102, the server 102 may be configured to exclude descriptions, which in previous cycles have been shown not to correlate with user A's provided description, from subsequent cycles. This reduces the number of descriptions which must be analysed in each processing cycle. Only those descriptions which were not analysed in the previous processing cycle are analysed—namely, only those descriptions which were received since the last processing cycle are compared with user A's description.

The server 102 then selects at step 152 the user B whose description correlates with user A's description. The user and contact details of user A and user B are then forwarded to their respective counterparts—namely, the user and contact details of user B are forwarded to user A, and vice versa. The process 130 is then ended at step 154.

FIG. 4 provides a functional overview of the server 102 in accordance with an embodiment of the present invention. The server 102 is provided with a user validation system 202, for determining whether a particular user attempting to access the system 100 is authorised to do so. (The validation system 202 achieves this by determining if the user is a registered user and is authorised to access the services of the present embodiment). This may be achieved by requiring that registered users maintain a stored user profile, comprised within a user profile database 104, which is accessible to the server 102. Before accepting a user generated description, the server 102 verifies that the user has a user profile, the presence of which confirms that the user is a registered user. Whilst both the validation system 202 and the user profile database 104 are optional and are not critical to the operation of the present embodiment, they do provide some advantages. For example, use of a user profile database 104 improves the user experience by minimising the amount of information a user must provide in the description of the shared-event. A description of a shared time-location event, received by the server 102 may be automatically supplemented, if required for reconciliation purposes, with pre-stored user-profile data. This may increase the accuracy of generated reconciliations. For example, information relating to the physical appearance of a user A may be obtained directly from the user's stored profile. In this way, the amount of information a user is required to actively provide for every different generated description forwarded to the system is minimised.

The user profile database 104 comprises a plurality of user profiles 206, of all users registered to use the system of the present invention. Each user profile 206 comprises a plurality of detailed information about the user, such as physical appearance, contact details, and any other characterising information about the user. Optionally the user profile also comprises a picture of the user.

A registration system 204 provides a mechanism for registering new users, who are not currently registered, and who would like to access and use the services of the present embodiment. Accordingly, the registration system 204 is provided with the functionality to create new user profiles 206 in the user profile database 104. A message handling system 208 is provided with receiving means for receiving a message corresponding to a user-generated description of a time-location event. The message handling system 208 reviews the received message and generates a formalised query comprising different types of variables, on the basis of the description. The generated variables characterise the time-location event, as recollected by the user—for example, user A. Optionally, the formalised query may be supplemented with user-profile information obtained by the server 102 from the user profile database 104. The formalised query is stored in a user query database 212 comprised of one or more user queries 214. The user query database 212 is accessible to the server, and in particular to both the message handling system 208 and the match generation system 210, and in certain embodiments may be comprised within the server 102. The match generation system 210 searches the user query database to identify a user B party to the shared time-location event. This is achieved by identifying a user B query which may be reconciled with user A's query. In effect, user B is identified by comparing the different user queries stored in the user query database 212, and identifying a query which correlates with user A's query. Since both user A and user B were party to the same event, there exist correlations between their respective descriptions of the shared time-location event. The present embodiment provides a method for identifying such correlations in the provided descriptions.

Alternatively, the user profile database 104 is searched directly by the match generation system 210, rather than initially searching the user query database 212. In such alternative embodiments once a message has been received from user A and processed by the message handling system 208, the match generation system 210 may initiate the reconciliation process by searching for existing user profiles 206 within the user profile database 104, to generate a shortlist of potential user B identities which may match user A's query. The identities of the potential user B's (the potential matches) are then used to identify any received associated user queries 214 within the query database 212. To complete the reconciliation process the match generation system 210 analyses the associated queries to identify correlations with user A's query. Using this method, the match generation system 210 is able to reconcile the query of user A with the query of user B.

In both described embodiments, following reconciliation, the match generation system 210 is adapted to provide users A and B with the contact details of the other user, which may be obtained from the user profile database 104, or alternatively if provided, from the user query 214.

FIGS. 5a, 5b, and 5c provide more detailed information regarding the method steps of FIG. 3, in accordance with an embodiment of the present invention requiring user registration.

FIG. 5a outlines in further detail the process step 134 of FIG. 3, and in particular outlines how the server 102 establishes that a received query message has originated from a registered user. It is to be recalled that the user query message may be issued from any one of the remote user terminals 106, 108, 110, 112, or 114 illustrated in FIG. 2. The server 102 determines if the query message received at step 302 has originated from a registered user at step 304 by cross-referencing a provided user identifier (typically comprised within the query message) with the user profile database 104. If the query message has not originated from a registered user, or the user's identity cannot be verified by cross-referencing with the user profile database 104, then the user is invited to register and create a unique user profile at step 306. The server 102 awaits for confirmation at step 308 from the user that they wish to register their user profile. If the user declines the invitation to register a user profile, then the query message will be refused at step 310, the user is declined access to the services of the system and the process is ended at step 312. If the user accepts the invitation to register a user profile in step 308, then the user is forwarded to the registration system 204 at step 314, where the user creates a user profile 206. The user profile 206 is stored within the user profile database 104, and is characterised by a unique user identifier. Further details concerning the registration process are set out below in discussions of subsequent embodiments of the present invention.

Once the user is registered, he/she may access and benefit from the functionality of the present system. If the received query message is determined by the validation system 202 in step 304 as originating from a registered user, then the query message is forwarded directly to the message handling system 208 in step 318.

FIG. 5b describes in further detail the process steps 136 and 138 of FIG. 3 carried out by the message handling system 208 and the match generation system 210. The message handling system 208 receives the forwarded message at step 319, analyses the received message, and generates a formalised query at step 320. The formalised query is generated from the information provided by user A in the forwarded message, and is used during the reconciliation process by the match generation system 210 to identify any correlated user queries. Further details of how the formalised queries are generated by the message handling system 208 is provided in the ensuing discussion of alternative embodiments of the present invention.

The generated formalised query is forwarded to the match generation system 210 in step 322. The match generation system 210 processes the formalised query in step 323, and searches the user query database 212 for any correlations between user A's formalised query and existing user query entries 214. At step 324 the match generation system 210 determines if any possible matches with existing user entries have been identified. If no possible matches have been identified, then the match generation system proceeds to wait at step 325 for a predetermined period of time before repeating the process of step 323. If however, at step 324 the match generation system 210 has identified possible matches, then a shortlist of results of possible matches (i.e. possible B's) with user A's formalised query is generated at step 326. The results are ranked in accordance with an associated correlation factor, calculated by the match generation system 210, which quantifies the probabilistic likelihood of a match between queries. The correlation factor is calculated for each possible match. Further details regarding the method of generating the correlation factor are described in ensuing discussions of alternative embodiments.

The match generation system 210 may use batch processing at step 323 to process formalised queries, or alternatively, formalised queries may be continuously processed as they are received by the match generation system. The choice of processing type, either batch or continuous, does not affect the functionality of the present system, and is at the service providers discretion.

In preferred embodiments the results are presented in sequential order to user A. At step 327 the result having the greatest associated correlation factor, in other words the result having the largest probabilistic likelihood of matching is presented first to user A for review. Alternatively, the one or more possible results are presented simultaneously for user A's review.

The identity of users associated with each of the possible results (i.e. the identities of the potential B's) is withheld from user A at this stage, and is not revealed until both user A and user B's queries have been mutually reconciled. Mutual reconciliation of both user A and user B's queries, requires that both user A and user B's queries are determined by match generation system 210 as being correlated. Additionally, in accordance with the presently described embodiment, user approval is required to complete the mutual reconciliation. However, this requirement is not essential in all embodiments of the present invention. In the current context, user approval requires that both users (i.e. user A and user B) have positively confirmed and approved the other user's description of the shared time-location event (as defined in each associated user's query) as relating to the same shared time-location event. All information which may compromise the identities of either user prior to confirmed user approval, is withheld from either user. For example, from the viewpoint of user A, the identity of user B is withheld until such time as user A has selected and confirmed the result which matches his/her issued query, and user B, whose query has been positively approved by user A as matching, has positively approved that user A's query matches his/her own query. By requiring that user approval is mutually reciprocal, the system ensures both users were party to the same shared time-location event, and that both users wish to be contacted and/or contact the opposite party. This requirement also helps to avoid abuses of the present system, and to prevent speculative use.

To maintain user anonymity during the user approval process, in preferred embodiments, the shortlist of results presented to either user is limited to time-location event data and the opposite users physical appearance data at the time of the shared time-location event. For example, the shortlist of results presented to user A for review, comprise only time-location event data and user B physical appearance data at the time of the event. All data is presented as obtained from user B's issued query. At this stage the physical appearance data excludes any images of user B. User A reviews the provided data and confirms if the system-identified result is a true match with user A's query—namely, user A verifies and confirms if the identified user B query relates to the shared time-location event, user A was party to. Similarly, the time-location event data provided by user A, in user A's issued query, is forwarded for review to user B. In this way, both users A and B assess whether the identified user is the person the time-location event was shared with, whilst maintaining user anonymity. The identities of the users are revealed once both users have approved the identified match as being a true match.

Returning to the discussion of FIG. 5b, in step 328 the match generation system 210 awaits receipt of user A's approval that the identified result is a true match. By true match is intended an identified result which relates to the same shared time-location event as user A's query. In the event that a negative response is returned by user A—confirming that the identified result does not relate to the same shared time-location event—then the match generation system 210 determines if any further results remain at step 329, and if so issues the next result, in step 330, from the shortlist of results generated in step 327, for user A's review. The match generation system 210 then awaits for user A approval in step 328. Steps 328, 329, and 330 are repeated until either user A has approved one of the shortlisted results, in which case the identified result is stored in step 332; or, no further possible results remain, in which case the match generation system proceeds to wait, as set out in step 140 of FIG. 3, for receipt of a further user message query, which may relate to user B's description. The process is ended if the time out period of step 142 of FIG. 3 expires before receipt of user B's query message.

Alternatively, instead of sequentially presenting results to user A for review, a shortlist of results, comprised of an arbitrary predetermined number of results is directly forwarded to user A for review in step 327. User A then selects the result which he/she believes to be correct from the provided shortlist. For example, the strongest ten results may be forwarded to user A for review.

FIG. 5c provides further details of the process steps 146 and 148 of FIG. 3, and shows how the server 102 ensures that reconciliation is mutual. User B's query is handled in exactly the same way by the server 102, as user A's query described in FIGS. 5a and 5b. Accordingly, once steps 302 to 332 of FIGS. 5a and 5b have been processed for user B's query in step 334, the server 102 and specifically the match generation system 210 determines at stage 336 if user B has positively confirmed a match with user A's query during the result review cycle process described in steps 327, 328, 329 and 330 of FIG. 5b. If positive confirmation has not been received by the match generation system 210, this may indicate that either user B has approved another user's query as matching his/her own, or that no matches have been approved by user B, in which case a message is forwarded, at step 338, to user A informing the user that approval has not been mutually successful—i.e. user B has not approved user A's query as matching his own, indicating that user B does not believe user A is the party the time-location event was shared with. If instead user B approves user A's query as a true match, namely that user A's query message relates to the shared time-location event, then the contact details of user A and user B are provided to respectively user B and user A, as described in step 152 of FIG. 3.

The contact details may include any communication and/or address details by which the users can contact each other, such as e-mail, contact telephone number, or mailing address. These provided examples of contact details are non-exclusive. Once the contact details have been issued, the process of the present embodiment is ended. The skilled addressee will appreciate that the forwarding of user contact information occurs only provided that positive confirmation is mutually reciprocated by both users within the default time-out period.

The above-described embodiment has been described from the point of view of user A. The skilled addressee should appreciate that the process outlined in FIGS. 5a, 5b, and 5c is experienced by every user that forwards a description of a shared time-location event to the server 102 for reconciliation. Accordingly, although the receipt of user A and user B's message has been described as occurring in a temporally sequential order for illustrative purposes, it is possible that both user A and user B's messages and associated formalised queries are processed in parallel, at substantially identical times, depending on when each user has respectively sent their initial description to the server 102.

Furthermore, the outlined process in FIGS. 5a, 5b, and 5c highlights how a match between two different received descriptions of a shared time-location event may be generated, in accordance with one embodiment of the present invention. The described embodiment requires that both users mutually verify the other user's description as relating to the same shared time-location event, before contact details are forwarded. Other embodiments of the present invention, which are discussed in further detail in the section related to alternative embodiments, may dispense with this requirement.

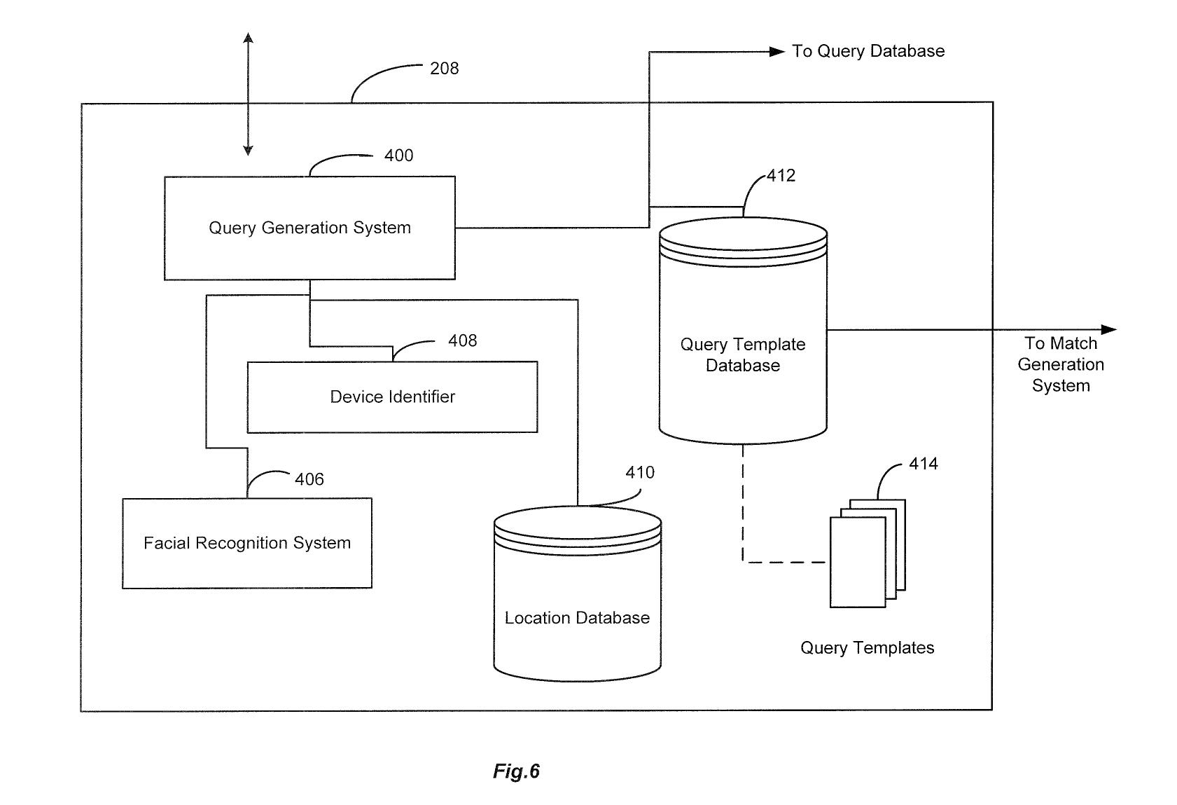

FIG. 6 is a schematic of the message handling system 208. In preferred embodiments, the message handling system 208 is comprised of a query generation system 400 for generating formalised queries from user provided messages, containing information describing a shared time-location event. The generated formalised queries are stored in a user query database 212, which is accessible to the message handling system 208.

In preferred embodiments, the message handling system 208 is provided with a plurality of additional systems, which may improve the user experience, by minimising the amount of user-provided information required to generate a match, and also help to facilitate the query generation process. The illustrated embodiment provides a message handling system 208 comprising a facial recognition system 406 for eliciting user information from image data, a device identifier 408 for identifying the type of user terminal being used to communicate with the server 102, and a location database 410. The device identifier 408 is used to facilitate the exchange of data with the user device. On the basis of the identified user device type, the server 102 will ensure all server-to-user terminal data exchanges are in a format suitable to the processing requirements of the identified user device. The device identifier 408 may also be used to ensure that the appropriate query template is forwarded to the user for completion. The format of the issued template must be suitable to the characteristics of user device 106-114. For example, a mobile device 106 typically has different device capabilities than a personal computer 108. A user on a mobile device 106 may desire to communicate via SMS, in which case all outgoing communications from the server 102 to that user device must be in the appropriate data format.

The message handling system 208 is operatively connected with a query template database 412, comprised of a plurality of different pre-generated query templates 414. The illustrated embodiment depicts the query template database 412 being located within the message handling system 208. The location of the query template database 412 is irrelevant, provided that it is accessible by the message handling system 208. Accordingly, alternative embodiments are envisaged wherein the query template database 412 is located externally to the message handling system 208, and may also be located externally to the server 102, provided that it is accessible to both the server 102 and the message handling system 208. The type of query template issued to a particular user may at least in part be determined on the basis of the identified user device type, and/or the type of shared time-location event. A more thorough discussion of the different types of query template is set out below.

The purpose of the query templates 414 is to elicit specific types of information concerning the time-location event from the user, in a format which is readily accessible by the message handling system 208. This helps to streamline the processing of received query messages by the message handling system 208, and facilitates the formalised query generation process. In a preferred embodiment, each pre-generated template 414 may be comprised of one or more different types of data entry fields. In turn, each different type of data entry field may be associated with a different type of information associated with the shared time-location event. Each different type of information, and accordingly each different type of data entry field may be associated with a different type of variable generated during the formalised user query generation process (see FIG. 5b, step 320) by the message handling system 208.

Each of the different query templates 414 is customised to facilitate eliciting information relating to different types of event content. A context, as used in the present description, describes the surrounding environment in which a time-location event occurs. It is to be appreciated that the amount of descriptive information regarding the time-location event, required to generate a reliable shortlist of results, is dependent on the context in which the time-location event occurs. To generate a reliable shortlist it is necessary that the user provide enough descriptive information, such that the specific shared time-location event may be uniquely defined. The information required to uniquely define a shared event will in part be dependent on the context of the event. For example, a time-location event occurring in a very crowded context, where potentially many users are sharing time-location events, will likely require more variables to uniquely define it, and to allow it to be distinguished from the plurality of other time-location events occurring simultaneously. In such a context, time and location information are insufficient to uniquely define the event. In comparison, an event occurring in a relatively isolated context, may be uniquely defined by time and location information only.

In a crowded environment further information, beyond time and location information is required to enable the server 102 to generate a match between two different users' description of the same shared time-location event.

The number of variables, or equivalently the amount of descriptive data required to uniquely define a time-location event, and hence to generate a reliable shortlist of results matching a user's query, is dependent on the context, or equivalently the environment in which the event takes place. The use of a query template database 412, addresses this requirement. It is noted as a general observation that the more crowded the environment in which the time-location event occurs, the more variables describing the event are required. For example, and returning to the above discussed example, in crowded environments information regarding visual descriptors of the event, which in the present embodiment is likely to include the appearance, gender, ethnicity, and the apparel of the user being sought for may be required to increase the probability of generating a match.

It is also desirable, in preferred embodiments, to minimise the amount of active data input required of a user A when completing a query template. Accordingly, each different type of query template is constructed in such a way as to elicit the required event data, using as few required data entry fields as possible, thereby increasing the efficiency (minimising data input by the user) and the usability of the system. Each different user template contains only as many data fields as required, to uniquely define an event of the selected context type. In other words, the query templates contain the minimum number of different types of data field, required to uniquely define the event of the selected context type.

Use of template is optional and different embodiments may use different methods of data event data capture. For example, in those embodiments dispensing with the use of the query template database 412, and where the user-provided description is unconstrained, text parsing may be used as a method of extrapolating the characterising variables from a user-provided textual description of the event.

One possible alternative option is the use of artificial intelligence (AI) systems (not shown) in server 102 to process unconstrained user-provided descriptions. For example, the message handling system 208 may be provided with a computational syntactic analysis system. A query template database 412 is not required in such embodiments. The syntactic analysis system can interpret both the content and context of a user provided textual description of the event. The syntactic analysis system is able to identify and generate the variables characterising the event from a user-provided textual description of the event. The elicited variable data is then forwarded to the message handling system 208, and specifically to the query generation system 400, where a formalised user query is generated.

In further alternative embodiments, user A may have the option to provide image data relating to the time-location event, such as a picture of user B the time-location event was shared with A facial recognition system 406 may be used to elicit data relating to user B from the provided image. Any elicited data may be used in the formalised query generation process, by the query generation system 400. The formalised query is then stored in user query database 212 as previously described.

If user A is using a mobile device 106 equipped with an image capture device (i.e. a camera), instead of or in addition to completing a query template, or a textual description of the event, user A may capture and provide an image of user B, and forward both captured image and the completed query template in a message to the message handling system 208. The image data is analysed by the facial recognition system 406, and elicited data is supplemented to the data elicited from the received query template. The facial recognition system 406 may elicit information relevant to user B's physical appearance, such as hair colour, hair length, eye colour, and even the colour of the user's apparel. Use of the facial recognition system 406 may further decrease the amount of data required by a user completing a query template, and is more convenient where the user terminal is a mobile device and the user wishes to decrease the amount of time required to forward the required event description information to the server 102.

The message handling system 208 may be adapted to provide support for GPS (Global Positioning System) enabled user terminals. The location and time of a time-location event may be provided by a GPS coordinate, as recorded by the user terminal at the time of the shared event. The skilled addressee will recognise a GPS coordinate as comprising both location and time data. In such embodiments, the user no longer needs to actively provide information regarding the location and time of the event, rather such information is provided by a GPS coordinate recorded at the time of the event. When the GPS coordinate is received by the message handling system 208, the received GPS coordinate is associated with a location in the location database 410 using a GPS-compatible global coordinate reference system, and populated into the generated formalised query. For example, a user A using a GPS enabled mobile device 106, can record the GPS coordinates of the event and send them directly to the server 102, where they are subsequently forwarded to the message handling system 208. Similarly, other automated mobile device location determination methods, such as position triangulation using mobile network base station signals, may also be used to define time and/or location data, and are readily integrated into the present system.

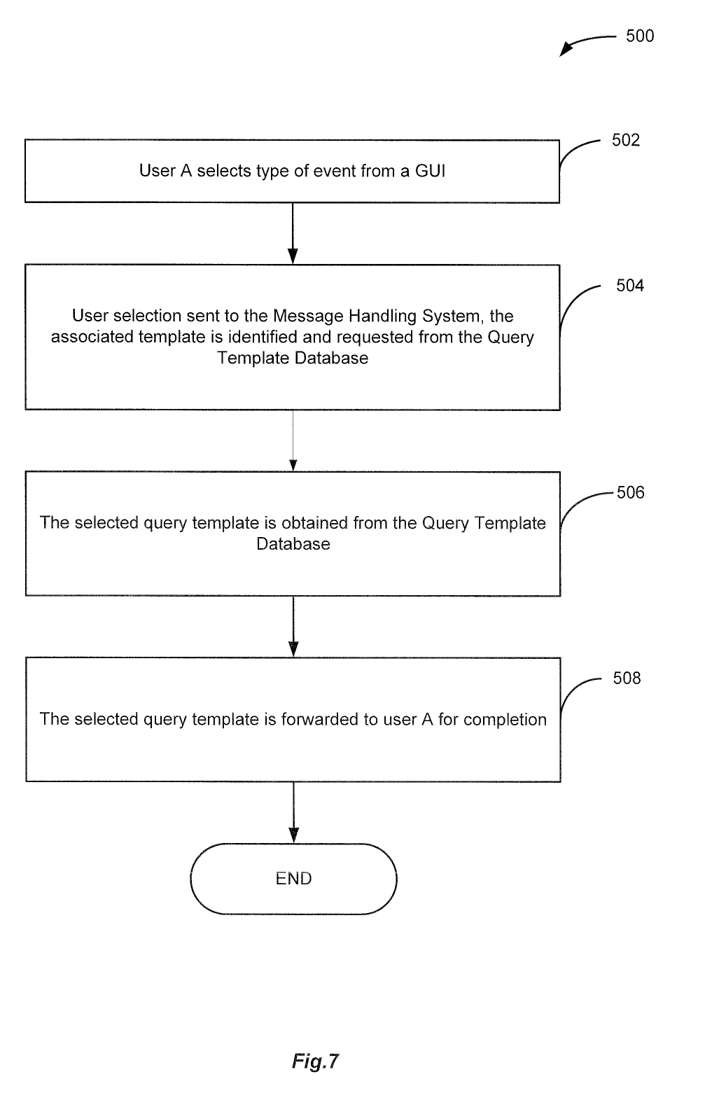

FIG. 7 outlines the process 500 of how the query template, appropriate to the specific context of the shared time-location event, may be selected and forwarded by the message handling system 208, to a user A in accordance with an embodiment of the present invention. The user A interacts with the server 102 via a graphical user interface (GUI). The GUI may either be accessed via an application stored locally on any one of user A's mobile device 106, personal computer 108, smartbook/pda 110, telephone 112 (provided the telephone is provided with processing functionality for running a locally stored application), and wireless device 114; or the application is remotely accessed by any one of the aforementioned devices. For illustrative purposes only, user A's device is taken to be a mobile telephone 106, having a locally stored application providing access to the server 102—the application comprising the GUI. On accessing the application, the GUI may prompt the user to select the type of shared event the user's query will relate to at step 502. The user's selection is sent to the server 102, and specifically to the message handling system 208, at step 504. On the basis of user A's selection, the message handling system identifies the appropriate query template suitable to, the context of the user-nominated event type, and requests the template from the query template database 412. The requested template is returned to the message handling system 208 from the query template database 412, at step 506. The returned query template is subsequently forwarded to the user A for completion by the message handling system 208, at step 508.

Alternatively, the query templates may be stored locally within the interface application, on the user A's mobile device (or any other device 106-114 used by the user). In such embodiments steps 504 to 508 are unnecessary. User A selects the type of event from the GUI and the locally stored application obtains the associated query template from local storage, for user A's completion. The returned, completed query template is analysed by message handling system 208, in accordance with the process flow chart of FIGS. 5a, 5b, and 5c.

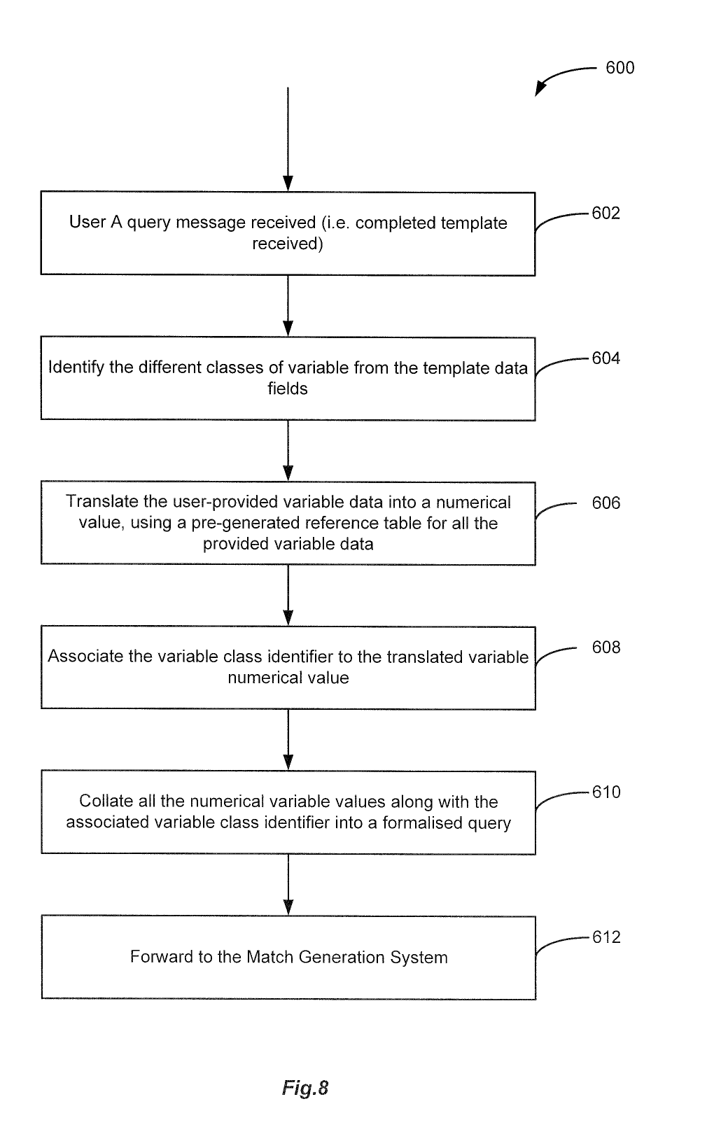

FIG. 8 is a process flow chart 600 illustrating how the message handling system 208 generates a formalised user query 214, for storage in user query database 212, from a user-completed query template received at step 602. The query generation system 400 analyses the received message, which relates to the user-completed query template and identifies the different classes of variable provided in the received template, at step 604.

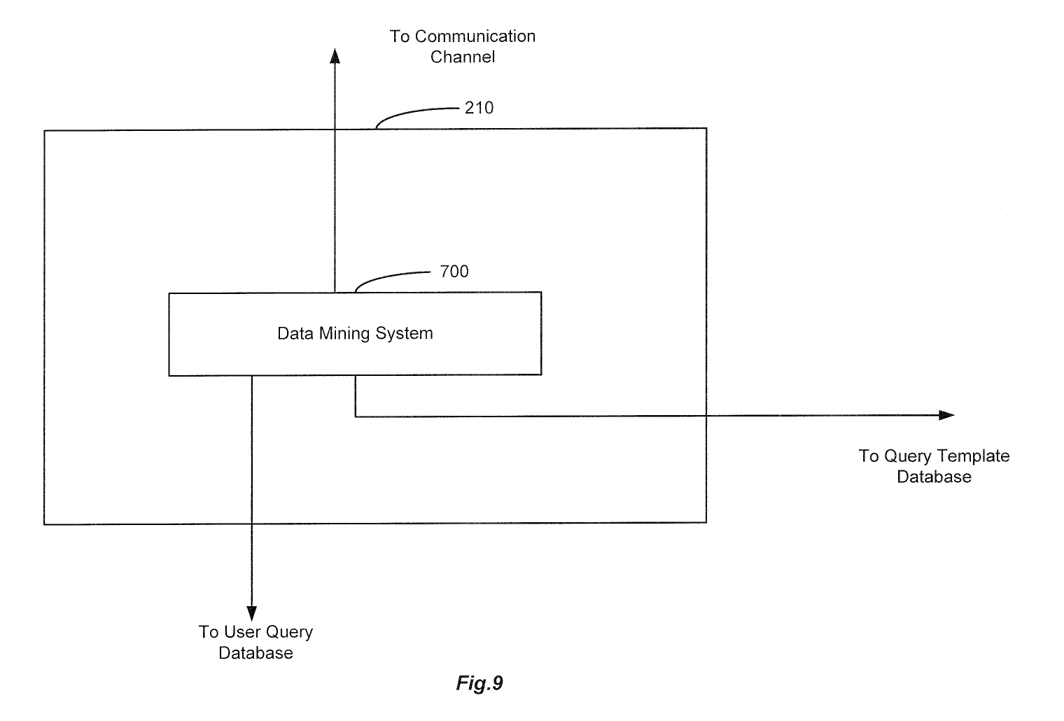

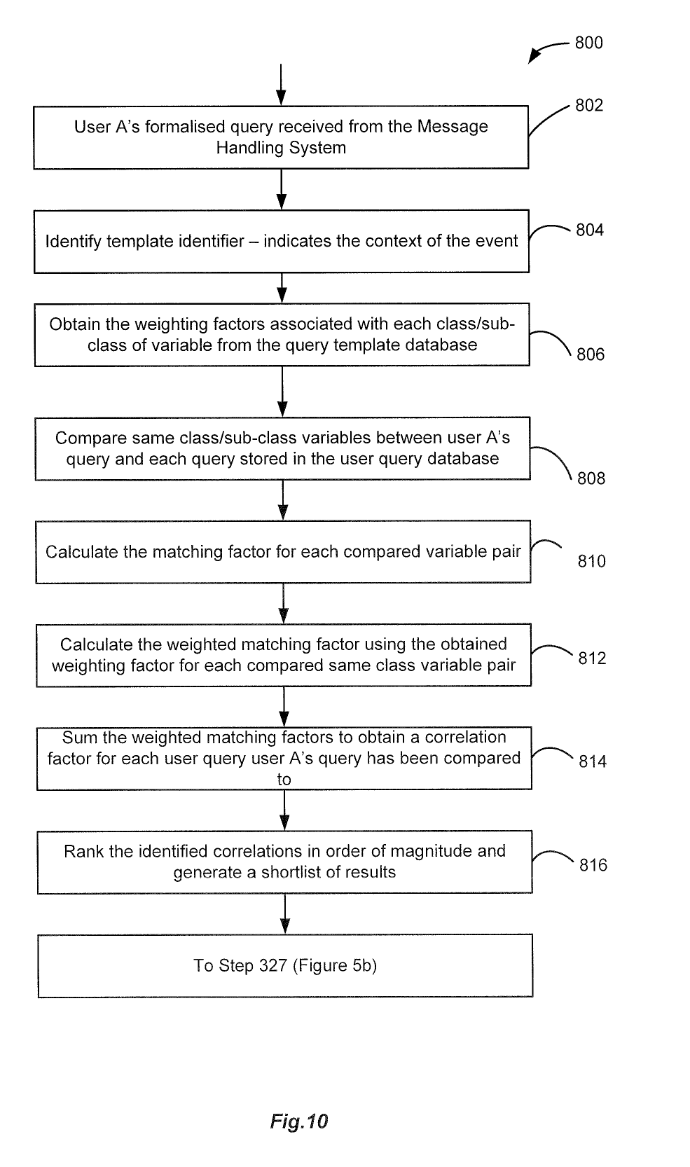

The reader may recall that the use of the term ‘variables’ in the present description, relates to any information which characterises the time-location event. Furthermore, the variables characterising the event may be separated into different classes or types of variable (within the present context the terms ‘class’ and ‘type’ are synonymous). For example, time and location data, relate to different classes of variable. Similarly, another different class of variable relates to visual descriptor data of the shared event. The different classes of variable may be further comprised of different sub-classes of variable. For example, visual descriptor data may further comprise sub-classes relating to user B physical appearance data, user A physical appearance data. For example, colour of hair may relate to one sub-class, whilst gender will relate to another different sub-class. The provided physical descriptor data of either user, is deconstructed into its component classes and sub-classes of variable. This hierarchical deconstructing, or splitting of variable data into different classes and sub-classes of variable is used in the match generation process, which is explained more thoroughly in the discussion of FIGS. 9 to 11.

Returning to the discussion of FIG. 8, which describes an embodiment wherein a user has forwarded a completed query template to the message handling system 208, the different classes and sub-classes of variable data are identified by the different data entry fields each user-provided variable relates to. Each of the data entry fields within a query template 414 relates to a different type of variable data. A variable class identifier, or sub-class identifier may be associated with each data entry field, and accordingly to each user-provided variable data. This may occur at the query template generation stage—that is when the query template database is created. In this way, upon receipt of a user-completed query template, the query generation system 400 is able to easily identify the class/sub-class of variable the provided data relates to, by simply reading the class and/or sub-class identifier associated with the data-entry field each user-provided data relates to, at step 604.

In alternative embodiments using AI system, and syntactic analysis systems, the systems can be instructed to associate a variable class/sub-class identifier to each different type of variable data elicited from the textual, or audio description of the event.

To generate quantifiable measures of the similarities between variables comprised in different received user queries, it is necessary to associate, or to translate, each user-provided variable into a quantified value—namely, into a number. In step 606 the query generation system 400 translates the user-provided variable data into numerical values. The query generation system 400 accesses a reference database comprising a lookup table. The lookup table associates a numerical value to all the different possible user-provided variable data. In other words, the lookup table associates a numerical value to each different possible descriptor data the user may specify. The reference database is a pre-generated database, and may comprise a different lookup table for each different class/sub-class identifier. The required lookup table is identified on the basis of the associated event descriptors class/sub-class identifier. The lookup table defines a numerical value for each ‘value’ the associated class/sub-class data variable may take. In this way, on the basis of the class/sub-class identifier associated with the provided descriptor data, the query generation system 400 is readily able to lookup the associated numerical value.

For example, FIG. 6 illustrates a location database 410 comprised of all the coordinate values that may be associated with a user's location. This is one example of a lookup table specifically restricted to one specific class of variable—location. For example a provided street name may be associated to a coordinate value in a lookup table within the database 410. Accordingly, a similar database may exist for each different class/sub-class of variable.

In alternative embodiments, a single database may be used to store either a plurality of lookup tables associated with the different classes and sub/classes of variable, or a single lookup table comprising all the different classes and sub/classes of variable and associated numerical values.

Once the process of translating each user-provided variable data into a numerical value using the lookup tables as described in relation to step 606 is complete, the associated variable class/sub-class identifier is associated to the numerical value in step 608. This allows the match generation system 210 to identify what type of variable each numerical value relates to, and is important for matching a user A's query with a user B's query. The process of referencing the lookup tables to associate a numerical value to each user-provided variable data, and subsequently associating the variable class/sub-class identifier to the numerical value is repeated for each user-provided variable data. Effectively, a user-completed query template comprising several different types of description data (user-provided variable data) is transformed by the message handling system 208 into a string of numbers, referred to as a formalised user query at step 610. The formalised user query is now in a format which is processable by the match generation system 210, and at step 612 the formalised query is forwarded to it. It should also be noted that the formalised query is also stored in the user query database 212, with the associated user query 214.

Although it has not explicitly been described in relation to the above discussion of FIG. 8, the reader may recall that a received user-completed query template may be complemented with additional data obtained from an existing user profile 206, comprised in a user profile database 104, as previously described. Such obtained data is also formalised in the aforementioned manner. In certain embodiments, data comprised in a user profile may be formalised (that is converted to a numerical value), on creation of the user profile. This provides the information in a form which does not require translation by the message handling system 208, and may be directly collated into the formalised query.

The practical advantage of transforming, or equivalently associating each user-provided variable data with a numerical value, is that now quantifiable comparisons may be made between variables common to two different user provided descriptions. In other words, quantifiable comparisons between same class/sub-class variables comprised in two different user-provided descriptions of a time-location event, as represented by the respective formalised queries may be made.

FIG. 9 illustrates a match generation system 210 in accordance with a preferred embodiment. The match generation system 210 is comprised of a data mining system 700, enabled to generate correlations between the variables of different formalised user queries stored in user query database 212 along with the associated user queries 214. Preferably, the correlations correspond to a matching factor, which is a probabilistic measure of the similarity between two variables. The match generation system 210 is provided with access to the query template database 412, such that a weighting factor associated with each different class/sub-class of variable may be obtained for the different types of query template. Alternatively, the weighting factors for each class/sub-class of variable are directly added to the formalised query by the message handling system 208 during formalised query generation. The matching factor and the weighting factor are described in further detail in the following discussion below.

In preferred embodiments, the data mining system 700 compares the variables of each received formalised query to generate a matching factor for each compared and matched class of variable associated with the received formalised queries. The matching factor is a measure of how closely two user-provided variables match. In other words, a measure of how closely correlated two variables associated respectively with different user queries are. Each class and sub-class of variable comprised in user A and user B's formalised query is compared and associated with a matching factor. In the present embodiment this may mean that each same-class variable pair is associated with one matching factor. Since each formalised query is comprised of several different classes of variable, the process of comparing same-class variables between two different formalised user queries is likely to result in a plurality of matching factors. A weighting factor is then applied to each calculated matching factor. The weighting factor is a measure of how important a particular class of variable is in determining whether two different descriptions of a time-location event relate to the same event. The weighting factor will be dependent on the variables required to uniquely define an event. For example, in reconciling an event which has occurred in a very crowded place, time and location are not sufficient to uniquely define the event. Accordingly, it will be important that other classes of variable, possibly user descriptor data also have a high degree of similarity—namely, that they are associated with a high matching factor. The weighting factor associated with the different classes and sub-classes of variable encapsulates this principle. Accordingly, the weighting factors associated with such user descriptor variables is likely to be greater for a formalised query relating to a crowded event context, than a shared time-location event occurring in a relatively isolated context. Where, as previously mentioned time and location data may be sufficient to generate a reliable match.

Each calculated matching factor is weighted by applying the relevant weighting factor as determined by the type of event, which incidentally may be determined from the type of user template selected by the user for recording the shared time-location event data. The weighted matching factors may then be summed to determine a correlation factor between the two user queries. In the present discussion the correlation factor relates to a numerical value which quantifies how closely related two different user descriptions of an event are, and indicate the likelihood that the two descriptions relate to the same shared time-location event.

Returning to the discussion of FIG. 9, the data mining system 700 may either periodically, or continuously review the formalised user queries associated with user queries 214 stored in user query database 212, to generate weighted matching factors between the different class and sub-class of variables contained in the formalised queries, and subsequently determining the correlation factor between the two user-provided descriptions. Equally, data mining system 700 may calculate weighted matching factors directly as new user queries are received.

FIG. 10 is a flow chart, providing an overview 800 of how the match generation system 210, illustrated in FIG. 9, reconciles two different descriptions of an event, provided by two different users, using weighted matching factors. For illustrative purposes, the functionality of the match generation system 210 is described with respect to a user A's formalised query, received from the message handling system 208 in step 802. Equally, user A's formalised query may alternatively be obtained by the data mining system 700 from the user query database 212.

In step 804 the match generation system 210, and specifically the data mining system 700 identifies the template identifier associated with the user-completed query template returned to the message handling system 208. Preferably this identifier is collated to the formalised query, in which case identification requires merely reading the identifier from the formalised query message. The template identifier indicates the context of the event to be reconciled. The reader should recall that the user template selected and completed by the user is selected on the basis of the context of the event. Accordingly, the weighting factors associated with the different classes and sub-classes of variable will be dependent on the context of the event, and accordingly on the template identifier.

In step 806 the match generation system, and specifically the data mining system 700 obtains the weighting factors for each class and sub-class of variable associated with the identified template identifier. Alternatively, steps 804 and 806 may not be required where the weighting factors are provided to the match generation system 210 in the received formalised query. In such embodiments, the weighting factors may be comprised within the user query templates 414, and are included in the formalised user query by the message handling system 208.

User A's formalised query is compared to each received user query stored in the user query database 212. In step 808, data mining system 700 compares the different classes and sub-classes of variable comprised in user A's formalised query with the same class and/or sub-class of variable comprised in the user queries stored in the user query database 212.

In step 810 the matching factor associated between two compared same-class variables is calculated. This calculation is possible since each of the classes and sub-classes of variable comprised within the formalised query relates to a numerical value. For example, consider the comparison of two variables relating to location. User A's formalised location variable may relate to a coordinate value generated by the message handling system 208. Similarly, potential user B's location variable is also represented by a coordinate value. The difference between the two values may be calculated and associated with a matching factor. One way of achieving this is to use a pre-generated scale. In such an embodiment predetermined distance differences may be associated with an arbitrary numerical matching factor. Preferably, the matching factor is normalised. For example, if the difference between the location coordinate values is 0 meters (i.e. the coordinate values are identical), then a normalised matching factor of 1 is associated with the compared variable pair. A coordinate difference of 500 m may be associated with a matching factor of 0.5, and similarly a coordinate difference greater than 1 km may be associated with a matching factor of 0, indicating that there is no degree of match between the variable values. The scale used for the purposes of generating the matching factor may be associated with the type of query template selected for use by the user, and may be stored along with the template in the query template database 412.

The skilled addressee will appreciate that whilst the current description only provides an example of a scale associated with a location class variable, similar scales will be associated with each different class and sub-class of variable. The general principle is to formalise a user provided variable data using a pre-determined numbering system—a system which defines which number is to be associated with the specific data. The difference or discrepancy between any two like-class variables is then determined by simply comparing the associated numerical values. In turn this quantified numerical difference may then be associated with a matching factor using a pre-determined scale. This method may be applied to any class and/or sub-class of variable.

The comparison of like-class variables relating to colour may use the LAB colour coordinate system. The skilled addressee will recognise the LAB colour coordinate system as associating a coordinate value to every different colour. The proximity of the coordinate values in the LAB colour space is reflective of the similarities in colour. Accordingly, red and orange will correspond to points which are closer to one another than say red and black. The distance between the coordinate points is proportional to the difference in the associated colours and is associated with a matching factor in an identical manner as described above.

In step 812 the weighted matching factor is calculated. The weighting factor obtained in step 806, or alternatively it may be directly comprised within the received formalised query, is used in calculating the weighted matching factor. This may involve multiplying the matching factor by the weighting factor to generate the weighted matching factor.

In step 814 all calculated weighted matching factors are collated to generate a numerical measure of the similarity between the two matched different user descriptions, referred to as the correlation factor. The collation may simply comprise summing all the weighted matching factors associated with the two compared user descriptions, to generate a number which is indicative of the similarities between the two descriptions and accordingly a measure of the likelihood that both descriptions relate to the same shared time-location event.

The process steps 802 to 814 are carried out between every received user query. Accordingly, the results associated with each query may be ranked in step 816, and presented to the user as illustrated in step 327 of FIG. 5b. As described previously, alternatively the user may be presented with a shortlist of results for review.

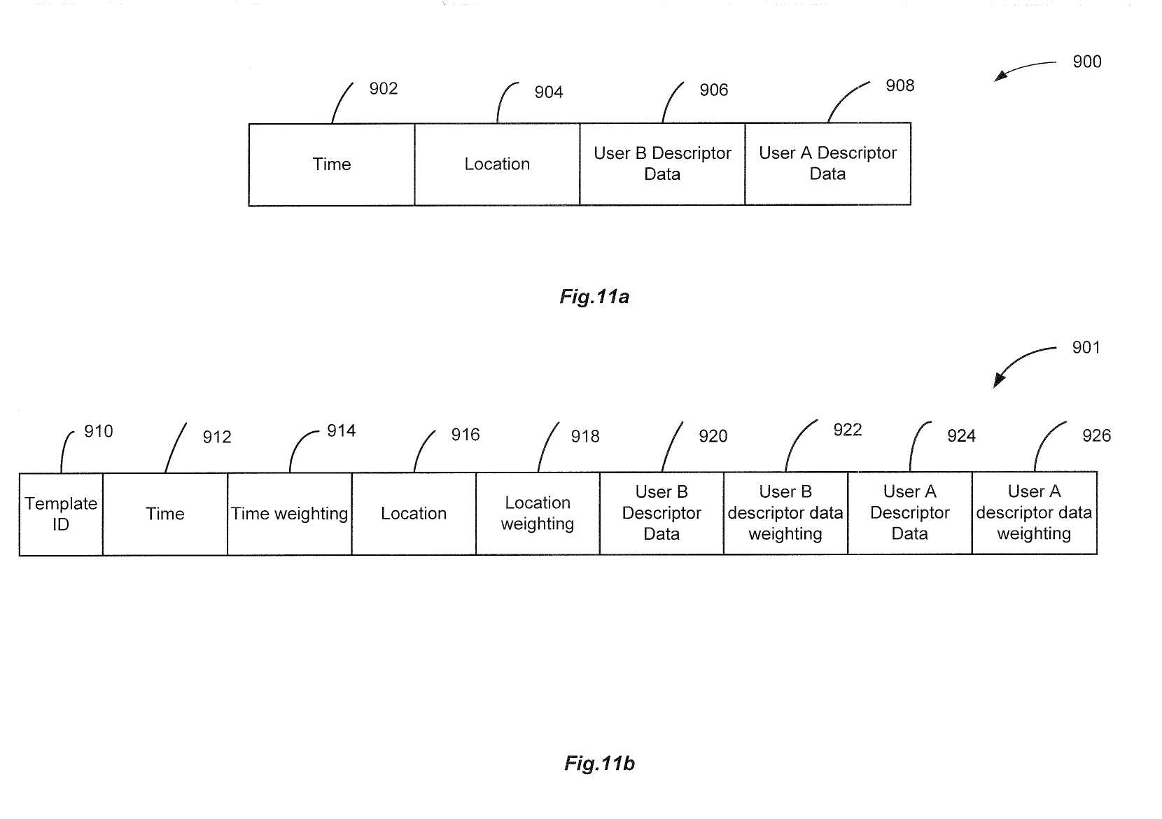

FIG. 11a illustrates the general structure 900 of a user message, received in step 319 of FIG. 5b by the message handling system 208. FIG. 11a effectively illustrates the data content of a user-completed query template. The user query is broadly comprised of four different classes of variable data, which in preferred embodiments are: time 902, location 904, user B descriptor data 906; and user A descriptor data 908. For illustrative purposes it is assumed that the illustrated query relates to user A's query however, all user queries will have the same general structure. The user B descriptor data 906, is descriptor data provided by user A, on the basis of user A's retrospective description of user B. The user A descriptor data 908, is preferably obtained directly by the message handling system 208 from user A's profile 206 stored in the user profile database 104, and collated to the user query. As mentioned previously, in alternative embodiments the user A descriptor data may also be actively provided by user A when completing the query template.

The user A descriptor data 908 is used for matching with the user A descriptor data as provided in user B's query. User descriptor data is required since time and location are often not sufficient to generate a reliable match.

FIG. 11 b illustrates the general structure of a formalised user query 901 in accordance with an embodiment of the present invention. In this embodiment the template identifier 910 and the plurality of weighting factors 914, 918, 922, and 926 have been obtained by the message handling system 208 during the query formalisation process and directly forwarded to the match generation system 210. FIG. 11b is comprised of four different classes of variable, namely time 912, location 914, user B descriptor data 920, and user A descriptor data 924. The reader should observe that each of the variables 912, 916, 920, and 924 relate to a numerical value, generated by the message handling system 208 during the query formalisation process. Furthermore, each class of variable is associated with a weighting factor. Time variable 912 is associated with a time weighting factor 914; location variable 916 is associated with a location weighting factor 918; user B descriptor data 920 is associated with a user B descriptor weighting factor 922; and user A descriptor data 924 is associated with user A descriptor weighting factor 926. Furthermore, both user B and user A descriptor data may further comprise one or more sub-classes of variable, in turn each sub-class being associated with a weighting factor. Accordingly, weighting 922 and 926 may relate to a plurality of weighting factors for each variable sub-class.

As mentioned previously, the advantage of using user A's user profile 206 for the provisioning of the user A descriptor data 908, is that this minimises the amount of information user A must provide, when completing the query template. In general, the user profiles comprise time-independent user descriptor data, such as physical appearance. Although the physical appearance of a user does change over a sufficiently long period of time, in the short-term it is expected that a user's appearance is constant. Accordingly, for present purposes physical appearance may be considered a time-independent descriptor data, and is not to be confused with user apparel—in the present context physical appearance and apparel are considered distinct from each other. Physical appearance may relate to hair colour, eye colour, and other features inherent to the user. Apparel and/or clothing are time-dependent descriptor data which are likely to change on a regular, typically daily basis. Such time-dependent user descriptors must be provided by user A on a regular basis. Such information may either be provided actively every time user A completes a query template, or alternatively, it is envisaged that user A may update his/her user profile 206 on a periodic basis to ensure that the time-dependent user descriptor data contained in the user profile 206, is accurate and up-to-date. For example, user A may decide to update his/her user profile on a daily basis (for example in the morning) to ensure that the profile accurately reflects his/her current apparel for that day.

User descriptor data may further include any of the following sub-classes of variable: gender; ethnicity; hair colour; hair style; eye colour; height; weight; apparel; and what actions the user was doing at the time of the event—was the user running, or reading a book? In preferred embodiments, the user descriptor data 906 and 908 may relate to any relevant data, which may be used by the match generation 210 in generating a match between two user queries.

Similarly, time 902 and location 904 class data relates to any data relevant to either the time or the physical location of the shared event. This may include the specific time when the event occurred, or a rough estimate thereof, or time ranges when the event is likely to have occurred. Equally, the location class data 904 may relate to the exact geographic location where the event occurred, or to approximate locations where the event is likely to have occurred, or any landmarks, or events.

In alternative embodiments, the system is adapted to handle indefinite user provided data—provided data which cannot be attributed an exact value. Such embodiments may incorporate AI systems using fuzzy logic in decision making processes. For example, user A may provide indefinite location information, such as specifying the name of a neighbourhood—e.g. the neighbourhood of Westminstér in London, or the Lower East Side in New York which cannot be associated with a precise location, and accordingly may not be associated with a precise numerical value. Although it is not possible to determine the exact location of the event from such provided data, it is still possible to associate an area of potential locations, and accordingly a range of numerical values to the location data. In such embodiments, the message handling system 208 may access the location database 410 to determine the plurality of potential definite geographic locations comprised within user A's indefinite provided location data. A matching factor is generated by match generation system 210, if user B's definite geographic location is found to be contained within the plurality of definite geographic locations comprised within user A's indefinite provided location data. The weighting factor associated with the determined matching factor is likely to reflect the associated uncertainty of the match, and accordingly a lower weighting factor will be associated with the matching factor.

Furthermore, match generation system 210 may generate the matching factor between the location-variables using fuzzy logic, to determine whether a match exists, on the basis of the plurality of locations that have been determined to lie within the indefinite location range specified by the user. In general, fuzzy logic may be used by the match generation system 210 to generate matching factors between user provided indefinite data variables, irrespective of the variable type.

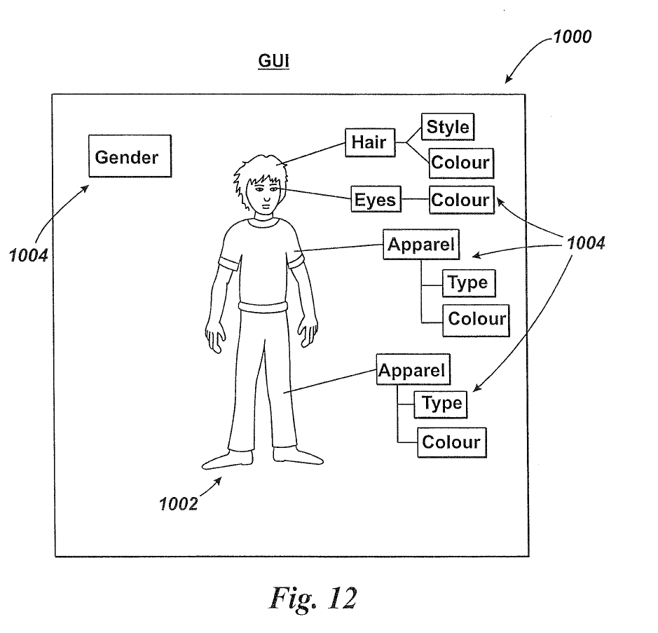

FIG. 12 illustrates a graphical user interface (GUI) 1000, used in embodiments of the present invention, where the user terminal comprises a screen and used by user A in providing user B specific data 904. For example, the GUI may be generated by an application running on an Apple iPhone®. As is clearly illustrated, the GUI 1000 is comprised of an arbitrary graphical representation of an arbitrary user 1002. The purpose of the GUI 1000 is to provide user A with an efficient and quick way for providing user B descriptor data 906. The GUI 1000 may be incorporated as part of a query template 414. The character 1002 is comprised of a plurality of data fields corresponding to different variables 1004 associated with user B descriptor data 906. Similarly, a user B will use a similar GUI to provide user A descriptor data when generating their message. GUI 1000 may be incorporated into the query template 414. Additionally, GUI 1000 may also include time and location data entry fields for providing of time 902 and location 904 class data. In such embodiments, the number and variety of classes and sub-classes of variable 1004 featured in the GUI 1000 is dependent on the type of query template 414 selected. As described previously, the type of query template 414 selected, is dependent on the context of the time-location event.

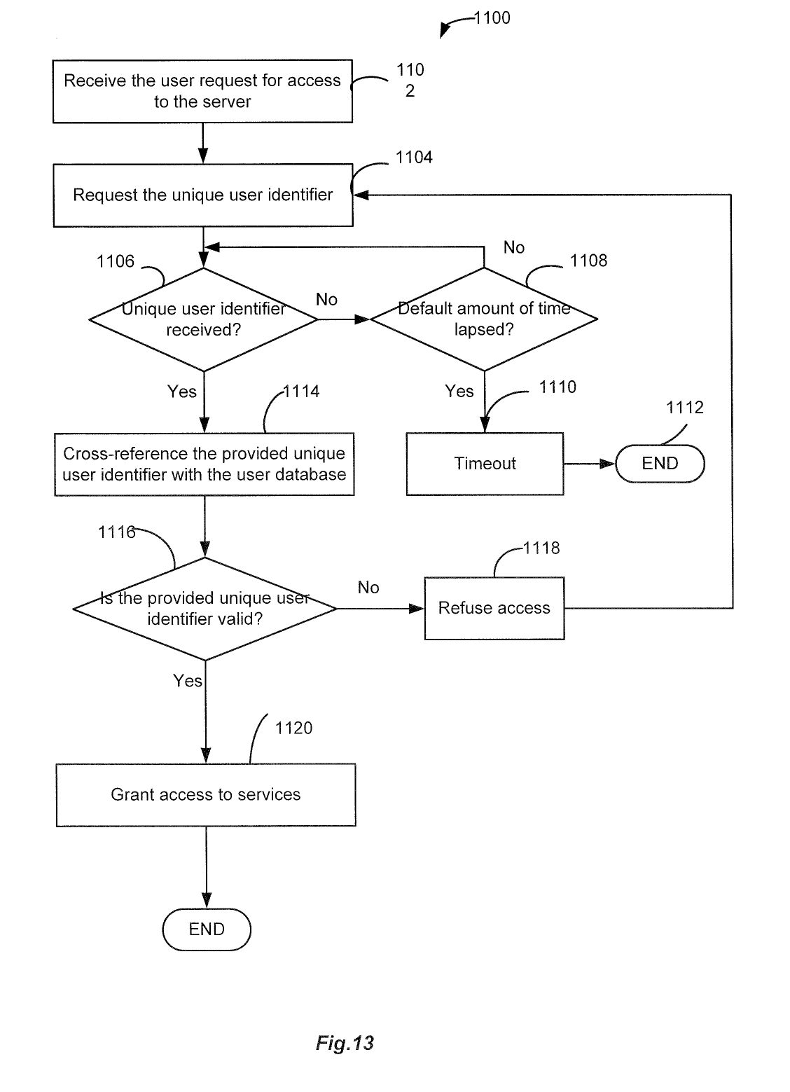

FIG. 13 is an overview 1100 of how the validation system 202 may determine whether the received query message 302 has been issued by a registered user in an embodiment of the present inventions. A user request for access to the server 102 is received at step 1102. The request may be incorporated into the received query message 302, or alternatively may be comprised in a separate data exchange, which preferably precedes receipt of the query message 302. Upon receipt of the user request at step 1102, the validation system 202 requests at step 1104 the unique user identifier, which uniquely identifies the user to the validation system 202. The unique user identifier may be requested by way of a user prompt, issued by the validation system 202, and appears on the user terminal 106, 108, 110, 112, or 114. The prompt may be a login screen, requesting a username and/or password. Alternatively, the unique user identifier may be stored locally to the user terminal 106, 108, 110, 112, or 114, and concatenated to the query message 302, to minimise the number of data exchanges required with the server 102. The validation system 202 awaits receipt of the unique user identifier at step 1106. The validation system 202 determines in step 1108 if a predetermined default amount of time has lapsed before receipt of the unique user identifier. If the unique user identifier is not received within this time, the validation system is timed out at step 1110, effectively ending the communication session with the user at step 1112. If the unique user identifier is received within the prescribed default amount of time, the validation system 202 cross-references at step 1114 the provided unique user identifier with the user identifiers contained in the user profile database 104, to determine if the provided unique user identifier is valid at step 1116. If the cross-reference concludes that the provided unique user identifier is invalid, access is refused at 1118.

Following a refusal of access, the user may be returned to the login screen where a request for a unique user identifier is again requested at step 1104. Equally, a subsequent prompt may be issued to the user stating that the provided unique user identifier is invalid, and entry of a valid unique user identifier may be requested. If instead the validation system 202 successfully identifies the provided unique user identifier as valid during cross-referencing, in step 1116, then access is granted at step 1120, and the received query message 302 is forwarded to the message handling system 208, where a formalised user query is generated as described previously.

The skilled reader will appreciate that the entire process illustrated in FIG. 13, may be incorporated into one or more data exchanges, to minimise the number of data exchanges required with the validation system to validate the identity of the user. This is particularly important where the user terminal is subject to bandwidth constraints, such as a mobile telephone 106.

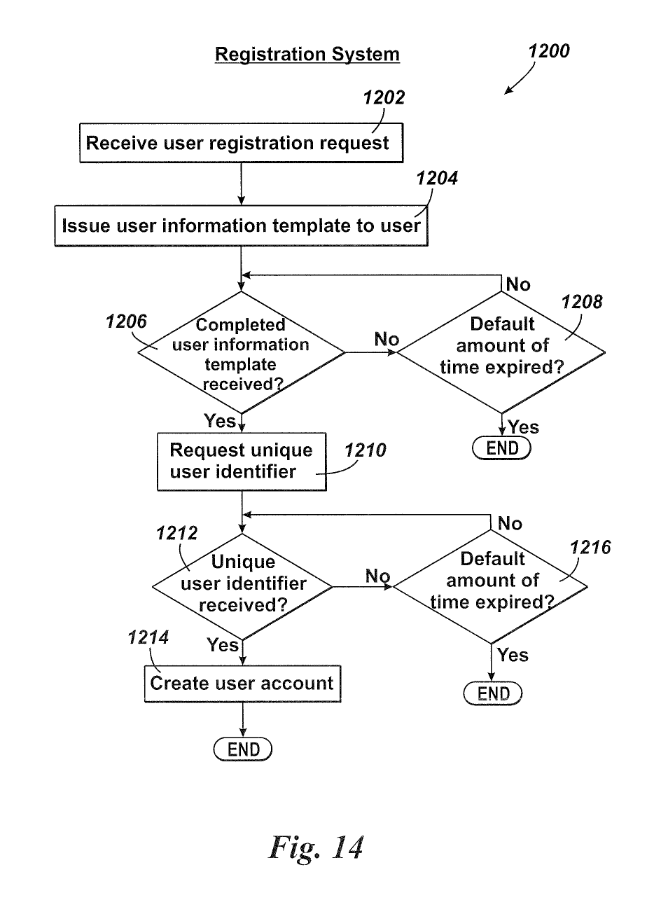

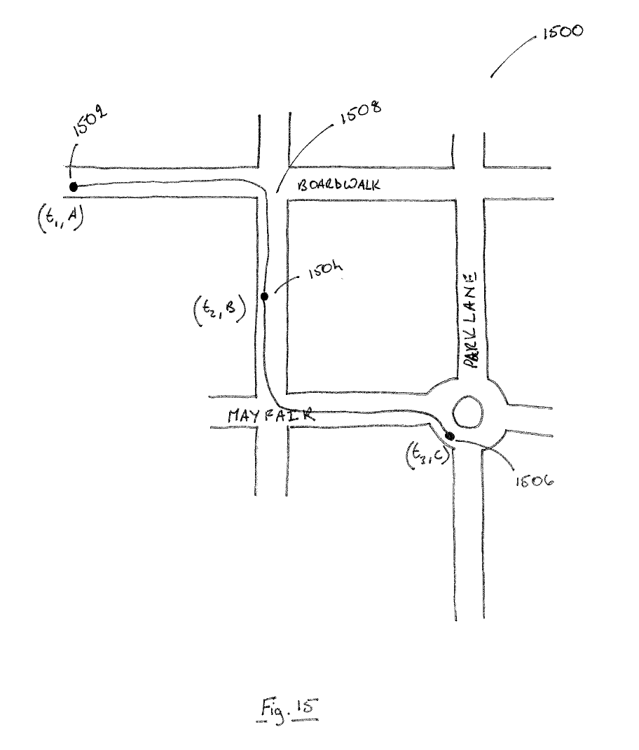

FIG. 14 illustrates an overview 1200 of how the registration system 204 functions in accordance with an embodiment of the present invention. If a user attempting to access the server 102 is not a registered user, the user may be invited to register as a user, as illustrated in step 306 of FIG. 5a. If the user confirms that they wish to register in step 308 of FIG. 5a, then the user's request is forwarded to the registration system 204, where the request is received at step 1202. In this embodiment each user is required to have a user profile 206. Preferably, the user profile is completed and provided to the system during registration, to avoid any incomplete user profiles, which may limit the utility of the user profile. A user information template is provided to the user. The user information template is a comprehensive template comprising a plurality of data fields, similar to the query templates 414. The main difference being that where the number of data fields comprised in the query templates is dependent on the context of the time-location event, the user data fields comprised in the user information template are not, and relate to user descriptor data entry fields. Any one user needs to only complete one user information template. Data relating to time-dependent user descriptor data such as apparel, may be updated on a regular basis, as described previously. Accordingly, the majority of the user profile template is comprised of user descriptor data relating to time-independent user descriptors, such as physical appearance. The reader will recall that in the present context, physical appearance is independent of apparel, and relates to the visually verifiable physical characteristics of a user. The registration system 204 awaits receipt of the completed user information template at step 1206. The registration system 204 determines at step 1208 if a default amount of time has lapsed without receipt of the completed user template. If the default amount of time has lapsed then the registration system 204 times out and the process is ended. Once the completed user information template has been received, the registration system 204 requests that the user nominate a unique user identifier at step 1210. The unique user identifier may relate to a unique password or other such unique identification means. Once the registration system 204 has determined at step 1214 that a unique user identifier has been nominated and received, then a uniquely identifiable user account is created at step 1214, and the registration process is effectively completed. Again, should the unique user identifier not be received within a predetermined time limit as determined at step 1216, then the registration process is terminated.

The unique user identifier is used to identify the user to the server, and specifically to the validation system 202 in subsequent communication sessions. On input of a valid user identifier a user may benefit from the services provided by the present system, and may also access and modify their user profile data if needed.

### FURTHER EMBODIMENTS

The reader skilled in the art will appreciate that although the present invention has been described within the context of a preferred embodiment, this is only one non-limiting embodiment, and there are many different alternative embodiments of the herein described methods and system, a few of which are described below.

The method and system disclosed herein reconciles two different descriptions of a shared time-location event, provided by two different users. In preferred embodiments, the system is provided with access to a user profile database 104 comprising a plurality of user profiles 206, as described above. However, It is not necessary that the user profile database 104 is local to the server 102 of the present system. Any existing user profile database which contains user profile data, including physical appearance descriptor data of a user, is suitable for use with the server 102. In certain embodiments it may be preferable to use such pre-existing user profile databases. Accordingly, the server 102 and methods of the present embodiment, may be used in conjunction with facebook™, twitter™, myspace™, eHarmony®, match.com™, or any other existing system, such as social networking systems, dating systems, or relationship systems which comprise detailed user profile databases. In such embodiments, the functionality of the present system and methods may be incorporated into the pre-existing system.

For example, the present system and methods may be incorporated as a facebook™ application, which uses the existing user database for formalised query generation purposes. If the existing user data contained in the user profiles is not sufficient for the purposes of reconciliation, then query templates may be used to elicit further required information. Alternatively, the existing user profile data may be complimented with additional user information required for reconciliation.

AI (Artificial Intelligence) and/or Neural Network Systems (NNS) may be incorporated in the message handling system 208, and/or the match generation system 210 of the present system. The AI and/or NNS may be used to generate customised query templates on the fly. The AI and/or NNS would assess the available information pertinent to an event, including user provided information, and user information contained in the user profile, and can determine what further information is required to increase the probability of successfully reconciling two user provided descriptions of the shared event—in other words determining what further information is required to generate a match between two different user's queries. Such a system presents clear advantages, insofar as the efficiency and effectiveness of the system will increase with time. The more reconciliations the system performs, the better and more accurate the system becomes, as it is effectively ‘learning’ from each reconciliation event. In particular, the decision-making processes of the system improves greatly with use. This includes the ability to determine what information is required to maximise the probability of generating a positive reconciliation, and the improved ability of generating associations—the system progressively becomes better equipped at determining whether associations exist between different users' variables, and determining the strengths of such associations. The skilled reader will have an understanding of the methods used by AI and NNS systems to ‘learn’, and accordingly, it is not necessary to discuss such details herein.

One very useful application of NNS and AI systems which may be employed within the server 102 relates to image recognition. It is envisaged that a user may provide their current apparel descriptor data by simply taking a photograph of themselves with for example, their mobile phone, and sending it to the server 102. The AI or NNS will readily elicit the different associated classes of variable associated with the image. For example, the AI or NNS will determine the colour of the apparel being worn, the general types of apparel and the overall appearance of the user that day, and update the user's profile accordingly.

Similarly, if the user A was able to capture an image user B, the image may be forwarded along with further event descriptor data. The image is analysed and the corresponding user B descriptor data is elicited and concatenated to the user description for analysis by the message handling system.

The ability of the AI and NNS systems to recognise images of people can be used to train the system as to what a particular user looks like by providing several different photographs of the user, provided either directly or taken obtained from a pre-stored database, such as a social networking database. These images can be used to build up an impression of what that user looks like to the system. This can be extremely helpful in the matching process. Rather than providing a description of the event, a user A may simply provide an image of user B. The matching system may then identify the associated user from the database and await for user B to confirm that they are looking for user A.

The use of GPS in accordance with the methods and system of the present invention, may significantly increase the user experience. As mentioned previously, GPS-enabled user terminals may be used to automatically record time and location data. However, the use of GPS is not limited hereto. GPS may be used to retrospectively extrapolate the approximate location of a time-location event on the basis of approximate event time-data. This is particularly useful when a user may not recollect where the shared event occurred, but may be able to deduce the approximate time of the event. For example, the event may have occurred on a user's walk to work in the morning, which by logical deduction might place the event within a specific timeframe—e.g. between 8:00 a.m. and 9:00 a.m. In this embodiment, the user's terminal, which might be a GPS-enabled mobile telephone 106, periodically carries out a time-coordinate measurement. In practice this means that a GPS-coordinate must be taken at periodic intervals and stored. When generating a message query for issuing to server 102, as described in step 302, on the basis of a provided time value, or range of values, the system may establish the location of the user from the stored GPS-coordinates. Furthermore, such a system is also adaptable to generate location-data when the user terminal suffers a temporary loss of the GPS signal. On the basis of the recorded GPS-coordinates, the system may extrapolate the user's location during the time period when the GPS signal was lost. For example, if a shared time-location event occurs on an underground train where the user does not have a GPS signal, it is still possible to retrospectively extrapolate the location of the user from the periodically recorded GPS-coordinate data, by simply providing an approximate time-value when the event is likely to have occurred. The skilled reader will appreciate that any location measurement technique, such as position triangulation using mobile telephone signals, may be used in conjunction with the present invention. Apple's iPhone® is equipped with a Google™ maps application, which is able to triangulate the mobile device's current position, by triangulating the position, using the mobile telephone base stations.

The functionality of the present invention may be provided for by an application, stored locally to the user terminal, configured to communicate remotely with the server 102 for reconciliation. For example, such a locally stored application may be an iPhone® app. In such embodiments, the application could incorporate existing functionality of the iPhone® in the reconciliation process. For example the Google™ maps position location function may be used to determine position data.

It is also possible to implement the invention on a text based input system such as an SMS or twitter™ based communication. In such cases the text may be interpreted by the server 102 using a semantic interpreter in order to generate queries.

As previously suggested, the present invention may be used to reconcile more than two different descriptions of a shared time-location event. For example, the functionality of the present invention may be used to reconcile three, or four different descriptions of a shared time-location event between three, or four different users. To facilitate the reconciliations, the users may be prompted to specify how many people were party to the shared event. In this manner the system is aware of how many different time-location event descriptions must be reconciled. Reconciliation of the descriptions is conducted in the same manner as previously described, with the exception that more than two different descriptions of a shared time-location event are being reconciled. Such an embodiment is particularly useful in practical situations where a user may have had an active encounter with two or more other users, such as a conversation at a conference, and retrospectively wishes to contact the other two or more users party to the shared time-location event. The present embodiment is suitable to those situations where the users do not possess the contact details of the other users party to the shared event, but nonetheless wish to establish contact.

The skilled addressee will appreciate that the system and methods of the present invention may be used to reconcile any plurality of user descriptions.

In yet a further alternative embodiment, the present invention may be used to map, or trace the movements of a subject, by a plurality of different users. Such an embodiment may be of particular use to police in tracking the movements of subjects. Such subjects may relate to wanted persons, criminals, missing persons or other sought after persons.

Using the methods described herein, one or more users record time-location event data relating to the sighting of a subject. This may be done using a PDA, or mobile telephone and generating a user query, as previously described. The user query, or subject-sighting data as it is more appropriately named in the current embodiment, is comprised of time-location specific data, subject-descriptor data, such as appearance and apparel, and optionally contact details of the user generating the query/subject-sighting data such that the author of the generated subject-sighting data may be retrospectively contacted if required. The GUI illustrated in FIG. 12, provides a convenient interface for the recording of subject-descriptor data.

The user query/subject-sighting data is sent to a central database where it is reconciled with other received user queries/subject-sighting data relating to the same subject. The different time and location data may then be analysed to construct a time-line of the subject's movement. The main difference with previously described embodiments, wherein two or more different descriptions of a shared time-location event are determined as relating to the same shared event, is in the definition of shared time-location event. In this embodiment a shared time-location event relates to two or more events occurring at potentially different times and locations, which relate to the sighting of a shared subject. In this embodiment, it is probable that the subject descriptor data will be associated with a higher weighting factor than time and location data. Matching is undertaken on the basis of the shared subject and not necessarily on the basis of a shared event.

It is anticipated that the one or more different received user queries/subject-sighting data of a shared subject are comprised of different time and location data. However, the subject-specific data, it is anticipated, will be significantly similar. The server 102 is configured to reconcile the one or more received subject-sighting data, by matching the provided subject-specific data comprised therein. As with previously described embodiments, a correlation factor is calculated and associated to each pair of received subject-sighting data.

The correlation factors quantify the likelihood of a match between each two or more received subject-sighting data. A substantially similar process as described previously for calculating weighted matching factors and correlation factors may be employed in this alternative embodiment. Similarly, fuzzy logic may also be used, as previously described, in the correlation determination process. Assessment of the provided time-location data serves to evaluate the feasibility of the subject's movement over a given time period. The time period may be evaluated by comparison of the time coordinates from the two or more recorded subject-sighting data. For example, it is unlikely that two different provided subject-sighting data, occurring at opposite locations of a city, and within five minutes of each other, relate to the same subject, despite any similarities in the provided subject-specific data. A very low matching factor would be associated with such compared subject-sighting data, possibly excluding the possibility of the two subject-sighting data relating to the same subject. The time-location feasibility assessment serves to minimise the number of erroneously reconciled subject-sighting data.

The server of the present embodiment automatically generates sets of one or more reconciled subject-sighting datum, on the basis of the associated calculated correlation factors. The datum with the greatest associated correlation factors are grouped into sets, wherein each set relates to sightings of the same subject.

One practical use of the above described embodiment is to aid the police in the apprehension of a wanted fugitive. On the basis of a disclosed description of the wanted fugitive, a user of the present system can record time-location event data upon sighting the wanted fugitive. In particular, the user of the present system can record the time and location of the sighting of the fugitive, along with any information regarding the fugitive's apparel. On the basis of the received recorded time-location event data, a time-line of the fugitive's movements may be drawn. The constructed time-line may be used by the authorities to aid in the apprehension of the wanted fugitive.

FIG. 15 illustrates an embodiment wherein recorded subject-sighting event datum, provided by a plurality of different users, is used to map, or trace the movements of a subject (such as a fugitive) on a map 1500. A first user sees a wanted subject and records the event of the sighting 1502, occurring at time t₁ and position coordinate A, using a PDA, mobile telephone or other similar portable device. Similarly a second user, records a second sighting 1504 of the subject, at time t₂ and position coordinate B. Likewise, a third user records a third sighting 1506, at time t₃ and position coordinate C. The recorded subject-sighting event data is received and analysed by a server 102. Correlation factors are generated and associated between each pair of received subject-sighting data, to generate sets of one or more matched subject-sightings. On the basis of the sets of one or more matched subject sightings, a time-line of the subject's movement 1508 is generated. The time-line aids the authorities in tracking the movement of a subject, which may be critical to solving a crime or other similar incident, possibly an abduction. The process of witness account acquisition is significantly facilitated by this alternative embodiment.

Subject-sighting event data may also be retrospectively recorded, after the sighting has occurred. A user may retrospectively record the sighting data retrospectively on a PC or other similar networked device. In such embodiments the user must actively specify the time and location data, whereas if the event is recorded on a portable device, such as a mobile telephone at substantially the same time as the event is witnessed, in-built time and location features of the mobile device may be used for the automatic provisioning of such data.

Furthermore, this embodiment may be used, by a user, to record time-location event data relating to a witnessed crime. The recorded time-location event data is then used by the authorities in collecting evidence for the apprehension of the suspect(s). For example, if a user witnesses a crime, such as a robbery, the user may immediately record time-location event data relating to the crime. Such data includes the time, location, appearance and any other data relating to the suspect. Upon receiving the one or more time-location event data, the system reconciles the one or more received time-location event data as relating to the same event and subject. Such an embodiment provides the authorities with an automated means for collecting witness accounts of an event, and for associating the one or more provided descriptions to a common shared event, ultimately aiding the authorities in the apprehension of the subject. Additionally, a time-line of the suspect's movements immediately following the crime may be constructed.

Where CCTV images are available, the time and location of received time-location event data, may be used to facilitate the identification of the appropriate camera and time-frame in which the event may have been recorded. Identifying the relevant CCTV camera and footage of a recorded event is often problematic and takes significant resources and man-hours. Potentially hours of footage from a plurality of different cameras needs to be reviewed, to locate the film footage of a crime. The present embodiment significantly facilitates the process of locating the correct CCTV camera and the required film footage. On the basis of received time and location data, the authorities can efficiently identify the nearest CCTV camera and time-period in which the event was recorded.

In yet a further envisaged embodiment comprising an image analysis system, a users gait may be determined from a video recording such as a CCTV recording of the user, and supplemented to the user query. In the present context the gait refers to the way that a user moves, which may be a unique characteristic of the user. The image analysis system analyses the video recording and elicits all descriptor data including the user's gait from the recording. A formalised query may then be generated from the elicited data, using the afore-discussed methods.

In an alternative envisaged embodiment, the method and system of the herein described preferred embodiment may be adapted to help users find other users having compatible characteristics. In this embodiment a reconciliation of user descriptor data only is made, since the users have not shared a time-location event. For example, a user A wishes to meet other users having certain specified characteristics. The user A creates a profile description of the character of the type of user he/she would like to meet, which is then translated into a formalised query using the aforementioned methods. This formalised query is stored in the user query database for reconciliation with other user-provided queries. A match is generated using the afore-mentioned methods however, the reconciliation process comprises matching the requested characteristics specified by a user A, with the user characteristics of a user B. In order that the reconciliation is mutual, the user requested user characteristics specified by user B in his/her formalised query, must match with the characteristics of user A. A positive match is made when the formalised queries mutually correlate. The generated formalised query will have a similar structure to the formalised query structure of FIG. 11b, with the exception that there is no time and location class of variable. User B descriptor data may contain information such as gender, hair colour, leisure interests, and any other desired user descriptor data. The user A descriptor data may be supplemented to the formalised query from the existing user A profile data. Similarly, a user B formalised query will comprise user A descriptor data (defined by the user B), and will also comprise user B profile data. Each of the like-class variables are compared and associated with a weighted matching factor using the previously described methods, allowing a correlation factor to be determined. On the basis of the calculated correlation factor the system may determine whether there is a likelihood of a match. Provided the correlation factor is large enough, indicative of the likelihood of a match, both user A and user B may be provided with the respective results of their query. Provided both users confirm a match, the user contact details are forwarded to respectively user A and user B.

This embodiment may further be provided with location service functionality, depending on the terminal device used by the user. For example, if a user A is using a GPS enabled mobile telephone to access the system, the system will determine user A's current location, using the inbuilt GPS functionality of the mobile telephone device. The system will then provide a shortlist of results (i.e. potential matches) on the basis of the location. In other words, the system will determine the location of all the potential matches, and will inform user A of the potential matches which are nearest to user A's location—the shortlisted results will be ranked in accordance with correlation factor and vicinity to user A's location.

Similarly, the above described embodiment may be adapted to work even when a connection to the remote server is unavailable, for example when a user A is travelling in the subway, and is unable to obtain a valid network communication signal. The user A device, which may relate to a mobile telephone, is equipped with a short-range communication device, for example bluetooth®, or NFC (near field communication). User A's mobile device is configured to broadcast user A's formalised query to any other user devices in the vicinity, and is also equipped to process any received user broadcast queries. A user B device in the vicinity of user A's mobile device, will process user A's broadcast query and compare it with user B's query to generate a correlation factor between the two queries. Provided the generated correlation factor is indicative of a match, user B's device will broadcast a positive correlation result to user A's mobile device. To ensure that the identified correlation is mutual, user A's device must equally determine the correlation factor and verify that there is a match, and broadcast this result to user B's device. Once both user devices have received a confirmation message from the opposite device, then the contact details of the users are exchanged such that both user A and user B can readily identify each other. Since both users are in relatively close proximity such details may comprise a description of the current appearance of the user, for example a description of their clothing, if the user is wearing a particularly distinctive hat or other clothing item. Alternatively, user B's location may be sent to user A's device, where user A may use an in-built location functionality to then navigate to user B's location. Similarly, user A's location may be broadcast to user B's device. Where both user A and user B are using a smart-phone device, such as Apple's iPhone®, the location of the users may be directly displayed on an electronic map, such as Google maps™, within the user device. Both users can then readily find each other.

The skilled reader will appreciate that only a small selection of the different applications and embodiments of the present invention have been presented. However, it is understood that embodiments not specifically disclosed herein, remain within the scope and spirit of the present invention.

1. A method of matching a first and a second different independently-created descriptions of an event involving at least two persons, the method comprising:
receiving each of the first and second descriptions;
generating a first set of descriptive variables from the first received description and a second set of descriptive variables from the second received description;
determining a matching value for each variable common to both the first and second sets; and
using the matching values of the first and second sets to establish the likelihood of whether the first and second descriptions describe the same event.

2. A method according to claim 1, further comprising:
attributing different weighting factors to a plurality of possible variables used to describe the event;
storing the different weighting factors;
applying, for each common variable, the corresponding stored weighting factor to the respective matching value to create a set of weighted matching values;
wherein the using step comprises using the weighted matching values.

3. A method according to claim 1, wherein the first and second set of variables include at least one of the following event defining categories: location and time/date.

4. A method according to claim 3, further comprising:
attributing different weighting factors to a plurality of possible variables used to describe the event;
storing the different weighting factors;
applying, for each common variable, the corresponding stored weighting factor to the respective matching value to create a set of weighted matching values;
wherein the using step comprises using the weighted matching values and the attributing step comprises attributing the highest weighting factors of all the variables to the location and time/date category variables.

5. A method according to claim 3, wherein any one of the location and time variables is provided using a global positioning system (GPS).

6. A method according to claim 1, wherein the using step comprises summing the matching values to determine an overall measure of the likelihood that the first and second descriptions describe the same event.

7. A method according to to claim 1, wherein the first and second set of variables include at least one visual descriptor variable describing a visual aspect of the event.

8. A method according to claim 7, wherein the at least one visual descriptor expresses the appearance of one of the persons related to the event.

9. A method according to claim 7, wherein the first set of variables includes at least one variable describing one of the at least two persons related to the event and the second set of variables includes at least one variable describing the other of the at least two persons related to the event.

10. A method according to claim 9, wherein the first description is provided from a communication device of a first user and the second description is provided from a communication device of the second user, and the method further comprises:
obtaining descriptive variables expressing the appearance of the first user from a pre-stored user-profile database and adding them to the first set of descriptive variables; and
obtaining descriptive variables expressing the appearance of the second user from a pre-stored user-profile database and adding them to the second set of descriptive variables.

11. A method according to claim 10, wherein the determining step comprises determining a matching value for variables derived from both user-provided descriptions and from the user-profile database.

12. A method according to claim 9, wherein the first set of variables includes at least one variable describing the appearance of first user at the time of the event.

13. A method according to claim 8, wherein the at least one visual descriptor comprises a variable selected from a graphical user interface describing the appearance of a person related to the event.

14. A method according to claim 1, wherein the generating step comprises parsing the received first and second descriptions and extracting the first and second sets of descriptive variables.

15. A method according to claim 14, wherein at least one of the first and second descriptions comprise a textual description and the parsing step comprises employing syntactical analysis to extract the first or second set of variables.

16. A method according to claim 14, wherein at least one of the first and second descriptions comprise an audio recording and the parsing step comprises employing audio analysis to extract audio portions representing the first or second set of variables and converting audio portions into digital information representing those audio portions.

17. A method according to claim 1, wherein the generating step comprises converting the first and second set of descriptive variables into numerical values to enable machine comparisons of the variables.

18. A method according to claim 17, wherein the generating step comprises converting each common variable in the first and second sets into a common format to enable machine comparisons of the variables.

19. A method according to claim 17, wherein the determining step comprises:
determining the numerical difference between the common variables of the first and second set of descriptive variables; and
comparing the numerical difference between common variables with a predetermined value to establish the amount of the corresponding matching value.

20. A method according to claim 19, wherein the comparing step comprises comparing the numerical difference between common variables with a predetermined range of values to establish the amount of the corresponding matching value.

21. A method according to claim 17, wherein a common variable in the first and second sets comprises location information and the determining step comprises comparing grid location references of the common variables.

22. A method according to claim 1, further comprising sending the results of the using step to each of a first user's communication device and a second user's communications device.

23. A method according to claim 22, further comprising ranking the results in order of the likelihood of whether the first and second descriptions describe the same event, and sending the results in ranked order to each of the first user's communication device and the second user's communications device.

24. A method according to claim 22, further comprising requesting confirmation from the first and second user communication devices that the sent results are correct.

25. A method according to claim 24, further comprising sending the contact details of the second user to the first user, and the contact details of the first user to the second user, on receipt of confirmation by both the first user and the second user that both the first description and the second description relate to the same event.

26. A method according to claim 22, further comprising sending a data template to each of the first and the second users' communication devices, wherein the descriptions of the physical event are provided by completing a data-entry template, the template being comprised of a plurality of different data fields; and wherein the different data fields relate to different types of variable.

27. A method according to claim 22, further comprising:
determining from the received first and second descriptions, the type of communication devices used to send the first and the second descriptions; and
modifying the results of the using step to be compatible with each of the first user's communication device and the second user's communications device.

28. A method according to claim 1, wherein the receiving step comprises receiving the first description before the second description, and the method further comprises generating the first set of descriptive variables for the first received description and storing the first set until such time as the second description has been received and the second set of descriptive variables has been generated.

29. A method according claim 28, further comprising sending the contact details of the second user to the first user, and the contact details of the first user to the second user, on receipt of confirmation by both the first user and the second user that both the first description and the second description relate to the same event, wherein the storing step comprises storing the first set of descriptive variables until such time as receipt of the confirmation from both the first and the second user.

30. A method according to claim 1, wherein the event comprises a series of linked events occurring sequentially in time at adjacent locations.

31. A system for matching a first and a second different independently-created descriptions of an event involving at least two persons, the system comprising:
a receiver for receiving each of the first and second descriptions;
a set generator for generating a first set of descriptive variables from the first received description and a second set of descriptive variables from the second received description;
a match determinator for determining a matching value for each variable common to both the first and second sets; and
a results generator for using the matching values of the first and second sets to establish the likelihood of whether the first and second descriptions describe the same event.

32. A system according to claim 31, further comprising:
weighting means for attributing different weighting factors to a plurality of possible variables used to describe the event;
a data store for storing the different weighting factors;
wherein the match determinator is arranged to apply, for each common variable, the corresponding stored weighting factor to the respective matching value to create a set of weighted matching values;
wherein the results generator is arranged to use the weighted matching values.

33. A communications device for use with a system according to claim 31, the communications device being arranged to create the first or second description regarding the event and to send the same to the system.

34. A communications device according to claim 33, wherein the device comprises a graphical user interface showing the appearance of any of the at least two persons and enables rapid selection of information describing the appearance of any of the at least two persons at the time of the event.

35. A communications device according to claim 33, wherein the device comprises a camera for capturing the appearance of any of the at least two persons, the description including a captured image providing the appearance of any of the at least two persons at the time of the event.

36. A communications device according to claim 33, wherein the communications device comprises a downloadable software application to enable the device to create the first or second description regarding the event and to send the same to the system.

37. A computer-implemented method of matching a first and a second different independently-created descriptions of a shared event involving at least two persons, the method comprising:
receiving each of the first and second descriptions of the shared event respectively from each of a first and a second user's communications device;
generating a first set of descriptive variables from the first received description and a second set of descriptive variables from the second received description, the first and second set of variables including the location of the event, the time/date of the event and at least one variable describing the appearance of at least one of the at least two persons;
determining a matching value for each variable common to both the first and second sets;
using the matching values of the first and second sets to establish the likelihood of whether the first and second descriptions describe the same event; and
sending the results of the using step to each of the first user's communication device and the second user's communications device.

38. A method according to claim 37, further comprising:
attributing different weighting factors to a plurality of possible variables used to describe the event;
storing the different weighting factors;
applying, for each common variable, the corresponding stored weighting factor to the respective matching value to create a set of weighted matching values;
wherein the using step comprises using the weighted matching values.

39. A computer system for matching a first and a second different independently-created descriptions of a shared event involving at least two persons, the system comprising:
a processor for attributing different weighting factors to a plurality of possible variables used to describe the event;
a data store for storing the different weighting factors;
a receiver for receiving each of the first and second descriptions;
a set generator for generating a first set of descriptive variables from the first received description and a second set of descriptive variables from the second received description;
a match determinator for determining a matching value for each variable common to both the first and second sets and for applying the corresponding stored weighting factor to the respective matching value to create a set of weighted matching values;
a results generator for using the weighted matching values of the first and second sets to establish the likelihood of whether the first and second descriptions describe the same event.

40. A communications device for use with a system according to claim 39, the communications device being arranged to create the first or second description regarding the event and to send the same to the system.

41. A communications device according to claim 40, comprising at least one of the members of the group comprising a mobile telephone, a laptop, a personal digital assistant, a wireless tablet computer, a computer, a portable WIFI device and a telephone.
